(19) United States
(12) Patent Application Publication
(10) Pub. No.: US 2019/0392683 A1
(43) Pub. Date: Dec. 26, 2019

(54) GAMING SYSTEM AND METHOD INCLUDING REPLICATING SYMBOLS

(71) Applicant: ADP GAUSELMANN GMBH, Espelkamp (DE)

(72) Inventor: Michael Charles Halvorson, Las Vegas, NV (US)

(21) Appl. No.: 16/019,511

(22) Filed: Jun. 26, 2018

(51) Int. Cl. G07F 17/32

(52) U.S. Cl. CPC G07F 17/3269; G07F 17/3209; G07F 17/3216; G07F 17/3213

(57) ABSTRACT

Various embodiments of a gaming system and method offer replicating symbols. For example, gaming system generates a plurality of symbols for a play of a game, wherein at least one of the plurality of symbols can be a replicating symbol. Replicating symbols can be used to enhance a game outcome or award for player during a play of the game. The gaming system can determine a path of motion for a generated replicating symbol. The path can be predetermined or dynamically generated for the generated replicating symbols. The gaming system may randomly generate stop positions along the path. The gaming system may deposit copies of the generated replicating symbol at the generated stop positions. The gaming system evaluates the plurality of symbols and any displayed replicating symbols for winning symbol combinations and for determining any awards based on the evaluated winning symbol combinations.

### FIELD OF THE INVENTION

The present disclosure relates to gaming devices.

### BACKGROUND OF THE INVENTION

Gaming machines that accept wagers in exchange for the opportunity to win awards or prizes are known. Gaming machines that offer new ways to win awards or prizes are needed to gain and retain players' interest in the gaming machines.

### SUMMARY OF THE INVENTION

Various embodiments of a gaming system and method generate a plurality of symbols for a play of a game, wherein at least one of the plurality of symbols can be a replicating symbol. Replicating symbols can be used to enhance a game outcome or award for player during a play of the game. The gaming system can determine a path of motion for a generated replicating symbol. The path can be predetermined or dynamically generated for the generated replicating symbols. The gaming system may randomly generate stop positions along the path. The gaming system may deposit copies of the generated replicating symbol at the generated stop positions. The gaming system evaluates the plurality of symbols and any displayed replicating symbols for winning symbol combinations and for determining any awards based on the evaluated winning symbol combinations.

In one embodiment, the path of a replicating symbol is determined in conjunction with a connector that is generated during a play of the game. In one example play of a game, the gaming system randomly generates a plurality of symbols. The gaming system displays the plurality of symbols. The gaming system also determines whether a replicating symbol was generated in the plurality of symbols. If the gaming system determines that a replicating symbol was generated in the plurality of symbols, the gaming system determines a distance between a predetermined point that is displayed in the game and a position of the replicating symbol. The gaming system may generate a connector between the predetermined point and the replicating symbol, wherein the length of the connector is based on the determined distance between the predetermined point and the position of the replicating symbol. The gaming system may display the connector. In some embodiments, the connector is a length of rope. In some embodiments, the connector is a length of chain. It should be appreciated that the connector can be formed from any suitable material. In some embodiments, the material used for the connector may influence how the connector operates during a play of the game.

The gaming system may determine a path along which to move the replicating symbol across the displayed plurality of symbols. The gaming system may determine the path based on the position of the replicating symbol, a location of the predetermined point, and the length of the connector. The gaming system may also randomly determine at least one stop position for the replicating symbol along the path. In some embodiments, the gaming system may move the replicating symbol along the path and deposit a copy of the replicating symbol (e.g., a second replicating symbol) at the at least one stop position. The second replicating symbol may be displayed over a symbol from the generated plurality of symbols in some embodiments. In other embodiments, the second replicating symbol may mask or replace a symbol from the generated plurality of symbols that was already displayed at the stop position. The gaming system may return the replicating symbol to its originally generated position (the position) in some embodiments.

In alternative embodiments, the gaming system does not move the replicating symbol from the position. Rather, the gaming system generates a copy of the replicating symbol to move along the path in some embodiments. In some embodiments, when the gaming system determines that no additional replicating symbols will be placed at stop positions, the gaming system determines one or more awards based on the generated plurality symbols and the second replicating symbol. In some embodiments, the gaming system ignores the symbol in the generated plurality of symbols that was already displayed at the stop position for purposes of determining the one or more awards.

In one embodiment, a gaming system includes a plurality of symbol display areas associated with a plurality of video based slot machine reels. For example, the gaming system may include five video based slot machine reels that are each associated with three symbol display areas. The gaming system further includes a plurality of symbol sets that each includes a plurality of symbols, where each symbol set is associated with one of the slot machine reels. For a play of a game, for each slot machine reel, the gaming system generates a plurality of symbols from the associated symbol sets for the symbol display areas of the reel. The gaming system evaluates the generated plurality of symbols for winning symbol combinations. The gaming system determines a payout amount based on winning symbol combinations along wagered pay lines. The gaming system also evaluates the generated plurality of symbols for triggering symbol combinations. If the gaming system determines that a triggering symbol combination was generated, the gaming system starts a bonus game. A play of the bonus game may include a predetermined quantity of game spins (or activations) for the bonus game. In some embodiments, the predetermined quantity of spins are free spins. In some embodiments, the player may pay for the predetermined quantity of spins. It should be appreciated that in some embodiments without reels, the bonus game includes bonus game activations.

In one embodiment, during a spin of the bonus game, the gaming system randomly generates and displays a plurality of symbols for the symbol display areas of the reels. In one embodiment, the gaming system determines whether a replicating wild symbol was generated in the plurality of symbols. If the gaming system determined that a replicating wild symbol was generated in the plurality of symbols in one embodiment, the gaming system determines a distance between a predetermined point that is displayed in the game and a position of the replicating wild symbol. The gaming system may generate a chain as a connector between the predetermined point and the replicating wild symbol, wherein the length of the chain is based on the determined distance between the predetermined point and the position of the replicating wild symbol. In one embodiment, the chain connects the replicating wild symbol with the predetermined point. It should be appreciated that the connector can be formed from any suitable material. In some embodiments, the material used for the connector may influence how the connector operates during a play of the game.

In one embodiment, the gaming system determines a path along which to move the replicating wild symbol across the displayed plurality of symbols. In one embodiment, the replicating wild symbol will replicate itself somewhere along the path. The gaming system may determine the path based on the displayed position of the replicating wild symbol, a location of the predetermined point, and the length of the chain. The gaming system may also randomly determine at least one stop position for the replicating wild symbol along the path. In some embodiments, the gaming system may move the replicating wild symbol along the path and deposit a copy of the replicating wild symbol (e.g., a second replicating wild symbol) at the at least one stop position. The second replicating wild symbol may be displayed over a symbol from the generated plurality of symbols in some embodiments. In other embodiments, the second replicating wild symbol may mask or replace a symbol from the generated plurality of symbols that was already displayed at the stop position. In some embodiments, the gaming system may return the replicating wild symbol to its originally generated position (the position). In alternative embodiments, the gaming system does not move the initially generated and displayed replicating wild symbol from the position. Rather, the gaming system generates a copy of the replicating wild symbol to move along the path in some embodiments. In some embodiments, when the gaming system determines that no additional replicating wild symbols will be placed (or replicated) at stop positions, the gaming system determines one or more awards based on the generated plurality symbols and the second replicating wild symbol. In some embodiments, the gaming system ignores the symbol in the generated plurality of symbols that was already displayed at the stop position for purposes of determining the one or more awards.

By providing replicating symbols, the gaming system provides new ways to enhance game outcomes and improved player awards, which reduces potential player disappointment with game outcomes and enhances player excitement for the game. The new potential to improve or earn greater awards creates a greatly improved sense of anticipation and game for players.

### BRIEF DESCRIPTION OF THE DRAWINGS

FIG. 1 is a perspective view of one embodiment of a stand-alone gaming device of a gaming system.

FIG. 2 is a functional block diagram of the gaming device technology components of the gaming system.

FIGS. 3A, 3B, 3C, and 3D illustrate one embodiment of a method of operating the gaming system having replicating symbols for enhancing awards.

FIGS. 4A, 4B, 4C, 4D, 4E, and 4F illustrate screen shots of one embodiment of a gaming system having replicating symbols for enhancing awards.

FIG. 5 illustrates one embodiment of a pay table in a gaming system having replicating symbols for enhancing awards.

FIG. 6 illustrates a screen shot of another embodiment of a gaming system having replicating symbols for enhancing awards.

FIG. 7 illustrates one embodiment of a plurality of gaming systems that are networked together and have replicating symbols for enhancing awards.

### DETAILED DESCRIPTION OF THE INVENTION

Various embodiments of a gaming system and method generates a plurality of symbols for a play of a game, wherein at least one of the plurality of symbols can be a replicating symbol. Replicating symbols can be used to enhance a game outcome or award for player during a play of the game. The gaming system can determine a path of motion for a generated replicating symbol. The path can be predetermined or dynamically generated for the generated replicating symbols. The gaming system may randomly generate stop positions along the path. The gaming system may deposit copies of the generated replicating symbol at the generated stop positions. The gaming system evaluates the plurality of symbols and any displayed replicating symbols for winning symbol combinations and for determining any awards based on the evaluated winning symbol combinations.

In one embodiment, the path of a replicating symbol is determined in conjunction with a connector that is generated during a play of the game. In one example play of a game, the gaming system randomly generates a plurality of symbols. The gaming system displays the plurality of symbols. The gaming system also determines whether a replicating symbol was generated in the plurality of symbols. If the gaming system determines that a replicating symbol was generated in the plurality of symbols, the gaming system determines a distance between a predetermined point that is displayed in the game and a position of the replicating symbol. The gaming system may generate a connector between the predetermined point and the replicating symbol, wherein the length of the connector is based on the determined distance between the predetermined point and the position of the replicating symbol. The gaming system may display the connector. In some embodiments, the connector is a length of rope. In some embodiments, the connector is a length of chain. It should be appreciated that the connector can be formed from any suitable material. In some embodiments, the material used for the connector may influence how the connector operates during a play of the game.

The gaming system may determine a path along which to move the replicating symbol across the displayed plurality of symbols. The gaming system may determine the path based on the position of the replicating symbol, a location of the predetermined point, and the length of the connector. The gaming system may also randomly determine at least one stop position for the replicating symbol along the path. In some embodiments, the gaming system may move the replicating symbol along the path and deposit a copy of the replicating symbol (e.g., a second replicating symbol) at the at least one stop position. The second replicating symbol may be displayed over a symbol from the generated plurality of symbols in some embodiments. In other embodiments, the second replicating symbol may mask or replace a symbol from the generated plurality of symbols that was already displayed at the stop position. The gaming system may return the replicating symbol to its originally generated position (the position) in some embodiments. In alternative embodiments, the gaming system does not move the replicating symbol from the position. Rather, the gaming system generates a copy of the replicating symbol to move along the path in some embodiments. In some embodiments, when the gaming system determines that no additional replicating symbols will be placed at stop positions, the gaming system determines one or more awards based on the generated plurality symbols and the second replicating symbol. In some embodiments, the gaming system ignores the symbol in the generated plurality of symbols that was already displayed at the stop position for purposes of determining the one or more awards.

### Gaming Device Platform

The features and advantages of the gaming system and method described herein may be provided to a player via a gaming device platform that includes various structures and components for allowing player interaction with the gaming device. While only one gaming device platform will be described in detail herein, the features, objects, and advantages of the gaming system described herein may be implemented in one or more alternative gaming device platforms.

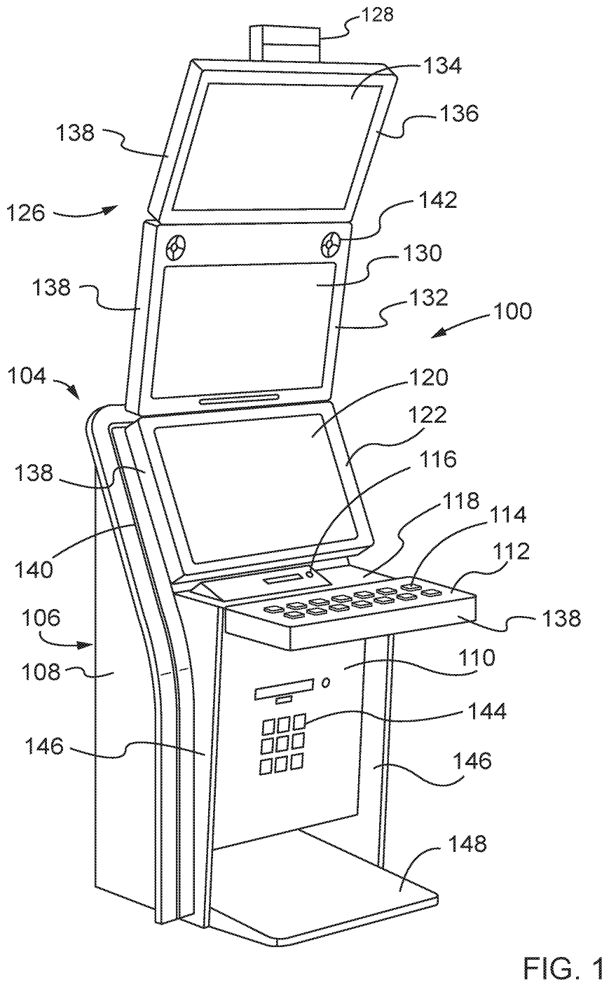

One embodiment of a gaming device platform is shown in FIG. 1 where a gaming device 100 is generally shown. In one embodiment, the gaming device 100 is referred to as a slot machine and is illustrated as housed in a housing or cabinet constructed so that a player can operate and play the gaming device 100 while standing or sitting.

Gaming device 100 may include cabinet 104 for housing the components fully described hereinbelow. The cabinet 104 has a lower cabinet body portion 106 which includes a pair of cabinet side panels 108 (only one of which is viewable in the perspective view of FIG. 1), front panel 110, and a rear panel (not shown). A base panel (not shown) and a top panel surface (not shown) that supports first game display 120 and the player interaction area 112, are provided. The cabinet panels are interconnected along their edges and cooperate to form a cabinet enclosure for housing the gaming device, as can be seen in FIG. 1.

It should be appreciated that a wide variety of cabinet enclosure sizes, shapes, and designs are possible for the gaming device 100. Cabinet 104 may function to securely protect any local control system, technology components, and provide support for game display(s) and player input and output interactions with the gaming device.

Returning to FIG. 1, the gaming device enables the player to interact with the gaming device 100 to direct the wagering and game play activities and preferences. Various forms of player interaction devices and activities will now be described.

Cabinet 104 includes a player interaction area having input and output areas generally designated as 112. The player interaction area 112 may be located on the front top side of cabinet 104 and, as shown, on a panel structure that extends outwardly from the gaming device in a player's direction. Player interaction area 112 may contain a plurality of player input and output structures such as player control button area 114, player value acceptor and dispenser area 116, and player convenience input area 118.

Player control button area 114 includes a plurality of buttons, touch sensitive areas, or both through with which players may interact with the one or more processors of gaming device 100 and direct game play. It is expected that cabinet 104 provides an easily accessible location and support for all necessary player input/output (I/O) interactions with the device, including gaming control interactions and value wagering interactions. Although the gaming device 100 illustrated in FIG. 1 shows player controls provided by buttons of player control button area 114, it is understood that in one embodiment, a player's gaming control interactions could be made by either buttons mounted on cabinet 104 or “soft” buttons located on the gaming display and activated by player touch (e.g., touch screen interfaces), or a combination of both arrangements.

Player control button area 114 may include, for example: game selection button(s) in any embodiments where more than one game is provided in a single gaming device; gaming denomination value selection button(s) in any embodiments where one or more wagering denomination value is accommodated; wager selection button(s) for the player to indicate or select the desired wager value for a game in any embodiments where a selection of wager values are offered; pay line selection button(s) for selecting the number of active pay lines in game embodiments that provide multiple pay line wagering; a reel spin button for players to initiate one or more reels to spin in a game; a repeat last bet button for players to conveniently repeat the last game's preference and wager selections in a new game; a cash-out button for player extraction of gaming device credits; an attendant call button; and gaming device information buttons such as show pay tables, show game rules, or show other game-related information. As discussed above, the functions of the buttons in player control button area 114 may be duplicated with soft buttons in the player control button area 114 or as soft buttons in other areas of the gaming device 100 (e.g., as a touch screen overlay over available game displays).

Gaming device 100 may include one or more forms of value acceptance and value distribution to allow the player to interact with the device and to risk or otherwise place a wager (a monetary value) on one or more outcomes of a game. Winnings may be returned to the player via some form of value distribution. As illustrated in FIG. 1, player value acceptor and dispenser area 116 is provided. In the player value acceptor and dispenser area 116, a player supplies monetary value to the gaming device 100 via one or more value acceptor devices. In one embodiment, the player value acceptor and dispenser area 116 (through the one or more value acceptor devices) may accept any one or more of the following from a player to establish a gaming credit balance: coins, bills, tokens, tickets/vouchers, player ID cards, credit cards, or other suitable forms of value. Thus, if the gaming device 100 accepts coins and bill, the gaming device 100 includes a currency bill validator and a coin validator as the value acceptor devices. Likewise, if the gaming device 100 accepts tickets, the gaming device includes a ticket acceptor as a value acceptor device for receiving tickets or vouchers representing some monetary value. The ticket acceptor may include a bar code reader, or other appropriate code reader, for reading the encoded value contained by the player's ticket or voucher. In some embodiments, the player value acceptor and dispenser area 116 may include a value acceptor device that can accept more than one type of value. In some embodiments, the player value acceptor and dispenser area 116 may include multiple different value acceptor devices to accept different types of value from players

Upon receipt of some type of value from the player, a value acceptor device of the player value acceptor and dispenser area 116 performs validation on the player supplied value using appropriate hardware readers (e.g., determining that the currency bills/coins/tokens are genuine or the ticket/voucher is genuine). If the validation result is positive on player supplied value, the appropriate value acceptor device generates a signal to a processor of the gaming device 100 to establish a gaming credit balance for plays of one or more games on gaming device 100.

In one embodiment, a player receives monetary value, or a representation thereof, from the gaming device 100 when a player chooses to “cash out” the gaming credit balance (e.g., remove value from the gaming device 100). The player can cash out at any suitable time. When a player cashes out the value contained on a credit meter (not shown) of gaming device 100, a processor of gaming device 100 may cause a printer of gaming device 100 to print and dispense a coded ticket or voucher through a dispensing slot to the player. The coded ticket or voucher may be a bar-coded ticket or any other suitable code (PDF417 coding or quick response (QR) coding). This ticket can then be used as value input at another gaming device, or converted to currency at a conveniently located kiosk or cashier counter located near the gaming device. Alternatively, the processor of gaming device 100 may cause a currency bill dispenser or a coin dispenser in gaming device 100 to dispense the value contained on the credit meter of gaming device 100.

Various combinations of the above value acceptance and value distribution arrangements are possible. Gaming device 100 may include other value acceptance and value distribution mechanisms in the player value acceptor and dispenser area 116. For example, gaming device 100 may include a magnetic strip or chip card reader/writer in order to accept value from and transfer value to a magnetic strip or an embedded chip card. In other embodiments, hardware for transferring (and receiving) non-traditional currencies to players such as digital currencies (e.g., bitcoin) may be included in gaming device 100.

In an alternative embodiment, gaming device 100 may include a card reader (not illustrated) in the in the player value acceptor and dispenser area 116, which accepts and reads any of a variety of magnetic strip or imbedded chip smart cards that convey machine readable information. The card reader reads inserted cards, in the case of wagering, for the credit information of the player for cashless gaming. The card reader may, for player loyalty programs, utilize the information on the card to identify the player account associated with the card so the gaming activity on the gaming device may be associated with the player account. It is noted that a numeric or alphanumeric keypad may be provided adjacent to the card reader slot to enable player entry of a personal identification number or the like for secure access to card information.

In one embodiment, a player convenience input area 118 may be included in the gaming device 100, as is shown in FIG. 1. In various embodiments, player convenience input area 118 may have a variety of features and functions depending on the jurisdictional deployment of the gaming device 100. In one embodiment, the player convenience input area 118 will house a magnetic strip card reader (not illustrated), integrated circuit chip card reader (not illustrated), or both, for reading cards associated with a player loyalty program. Player loyalty programs, also referred to as player tracking systems, provide magnetic strip or chip cards to players for insertion into a gaming device during play. These player loyalty/player tracking cards are associated with a player account and are utilized by the card-issuing entity to monitor, or track a player's gaming activity and build loyalty through player rewards of a variety of types. The player convenience input area 118 may include an input mechanism such as input buttons so that a player may input a personal identification number or other require player information associated with the player tracking card. Further, the input mechanism may also include a small display utilized to communicate player information to the player such as the player's current loyalty rewards.

In certain embodiments, the player convenience input area 118 may include player convenience features such as a pocket for storage that allows players to store their personal items such as a mobile phone. Gaming device 100 may include one or more universal serial bus (USB) ports that enables a player to charge their electronics or connect to services such as the Internet or food service. Further, player convenience input area 118 of gaming device 100 may include buttons to request food or drink service if the gaming device is located in an establishment that has food and drink service. The gaming device 100 may be connected to a local or wide area network such that selection of the requested food or drink service will alert the establishment's hospitality staff to deliver the requested service directly to the gaming device 100.

The layout of the player control button area 114, player value acceptor and dispenser area 116 and the player convenience input area 118 in gaming device 100 may be arranged differently than those disclosed and illustrated herein. The selections and arrangement of input locations on the cabinet 104 may be dependent upon the game buttons, the type of value wagered, and the player conveniences utilized in the deployment configuration of gaming device 100.

With continuing reference to FIG. 1, in one embodiment, lower cabinet body portion 106 includes a first game display 120 mounted atop or flush with the lower cabinet body portion's top panel surface. First game display 120 is, for example, a 27-inch liquid crystal display (LCD) display mounted in a widescreen orientation. However, any suitable display may be used in any suitable orientation. In the illustrated embodiment, the first game display 120 is mounted within and framed by first display frame 122 which is, in turn, mounted upon lower cabinet body portion's top panel surface. In this manner, the first game display 120 is both surrounded and secured within the first display frame 122 and raised above the cabinet's top panel surface. Additional features of the first display frame 122 will be described below. In one embodiment, gaming device 100 may use one first game display 120 and not include additional game displays (not illustrated).

The lower cabinet body portion 106 is further constructed to support upper cabinet portion 126. Upper cabinet portion 126 may be comprised of an upwardly extending support structure (not illustrated) that extends upwardly from the rear side of lower cabinet body portion 106 and is sufficiently strong to support one or more additional game displays.

At the topmost end of the support structure, a cabinet top light 128 may be provided. The cabinet top light 128 is capable of illumination in a variety of colors and is utilized to indicate and communicate gaming device conditions to gaming players and service personnel.

Further, the upper cabinet portion support structure may conceal power and communication lines between (1) the control systems and components located within the lower cabinet body portion 106 and (2) the displays mounted on the upper cabinet portion 126 support structure.

In one embodiment, as illustrated in FIG. 1, gaming device 100 includes two additional displays, second game display 130 and third game display 134. Second game display 130 and third game display 134 are disposed generally in a vertical relationship and generally in alignment with the first game display 120. Like the first game display 120, second game display 130 and third game display 134 can be 27-inch LCD displays and can be mounted in a widescreen orientation in one embodiment. However, any suitable display in any suitable orientation may be used for the second game display 130 and the third game display 134. Further, like the first game display 120, second game display 130 and third game display 134 can be mounted within and framed by second display frame 132 and third display frame 136, respectively. Second display frame 132 and third display frame 136 are attached to the upper cabinet support structure and can protect the second game display 130 and the third game display 134.

First game display 120, second game display 130, and third game display 134 can be disposed at an angle from each other to form a player-facing concave arc. However, in some embodiments, the angles between the displays may be adjustable and may be smaller or greater than the angles illustrated in FIG. 1. Further, it is understood that in some embodiments the displays may be disposed in a common plane relative to each other.

It also should be appreciated that in various embodiments a variety of display technology may be utilized equivalently and interchangeably with a variety of embodiments of the gaming device. Equivalent display devices include all variations of liquid crystal displays, light emitting diode displays, and plasma displays.

In some embodiments, different sized displays may be combined to display gaming data on gaming device 100. As a non-limiting example, a 27-inch widescreen LCD display may be combined with a 20-inch portrait oriented LCD or a light emitting diode (LED) display. This combination may be used, for example, with a third scrolling banner LED display. In alternative embodiments, one, two, three, or more displays could be used in a variety of positions and orientations. Any suitable combination may be used. It should also be appreciated that a processor of gaming device 100 may communicate with the disclosed first game display 120, second game display 130, and third game display 134 through a video card of gaming device 100 to produce the visible aspects of a game.

In one embodiment, one or more of the first game display 120, second game display 130, and third game display 134 may be fitted with a transparent touch sensitive overlay for sensing player touch inputs into the gaming device. Touch sensitive overlays can communicate with a processor of gaming device 100 to enable the player to interact with the game.

In some embodiments, the curved displays may be used for any or all of the first game display 120, second game display 130, or third game display 134. Similarly, any of the displays used for gaming device 100 can be based on flexible display technologies. For example, it is possible to utilize flexible display technologies to create uniquely shaped curving, wavy, or tubular display structures to provide one or more of the first game display 120, second game display 130, and third game display 134. Additionally, in one embodiment flexible display technologies can be used in combination with fixed flat screen technologies.

While the gaming device 100 has been described as implemented with video technologies, in one embodiment, mechanical reels with reel strips containing game indicia and step motor controllers may be employed to provide game information to a player. In one embodiment, the reel strips may include a plurality of printed symbols. In another embodiment, the mechanical reels may include flexible video display technology as the reel strips on mechanical reels. Thus, games implemented in video form can readily be implemented with mechanical reels utilizing such display technology. Alternatively, in other embodiments mechanical reels with reels strips having fixed symbols displayed along the reel strip could be used to implement the game.

Dependent upon the particular gaming device housing style, a variety of other display technologies may be utilized in combination with the gaming device disclosed herein. For example, in some embodiments a gaming device may have one or more display devices in addition to the main game display(s). For example, the gaming device may include a player tracking device having a player tracking display which displays various information to the player regarding the player's status. The gaming device may also include other game-related displays such as the wager display and the gaming credit balance display. These additional game-related displays may be separate display devices or may be displayed on any one or more of the first game display 120, the second game display 130, or the third game display 134.

Cabinet lighting design functions to attract players to a gaming device 100. In the embodiment of FIG. 1, attractive cabinet lighting is provided by frame accent lighting 138. It is noted that frame accent lighting 138 is a common structure found on each of the first display frame 122, the second display frame 132, and the third display frame 136 and player interaction area 112. Example areas where frame accent lighting is applied to gaming device 100 are commonly designated as frame accent lighting 138.

Frame accent lighting 138 may have multiple components. The side edge pieces of first display frame 122, second display frame 132, third display frame 136, and the edge structure of player interaction area 112 can be made of a translucent or transparent plastic or other suitable materials. Linear arrays, or strips, of light emitting diodes (LEDs) (not shown) on circuit boards may be mounted below the translucent or transparent plastic side edge pieces 138. In one embodiment, the circuit boards are flexible circuit boards. These LED strips and transparent or translucent coverings may surround one or more gaming device displays frames, as well as the player interaction area, to highlight these areas.

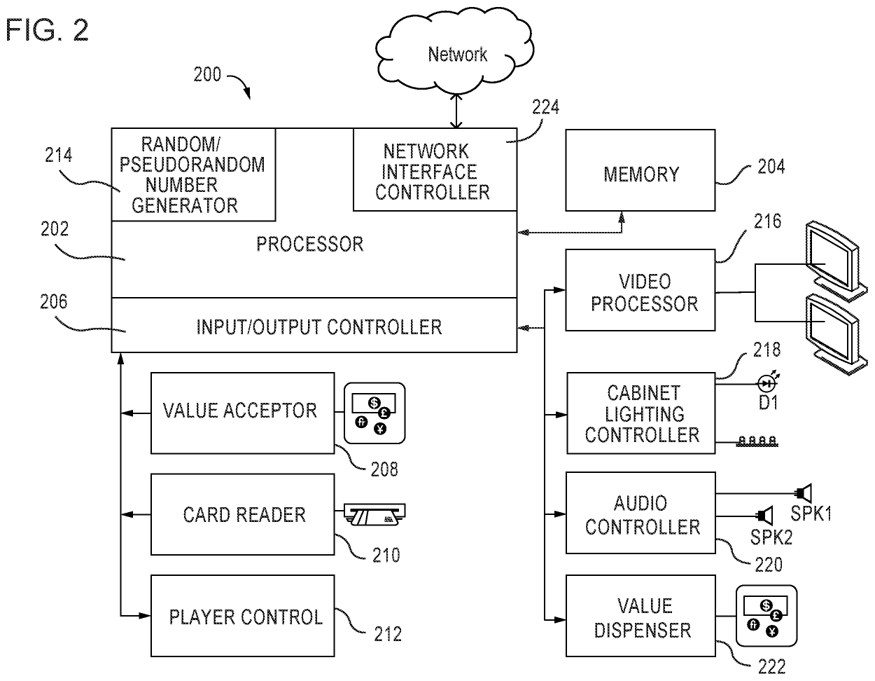

In one embodiment, the individual LEDs mounted on the LED strips are of a type that can emit red, green, and blue light. In an alternative embodiment, separate LEDs are used for each required light color. All LED strips can be electrically connected and can be controlled by a cabinet lighting controller 218 (illustrated in FIG. 2) in conjunction with a processor of gaming device 100 to selectively mix the emitted light colors in a manner to create any color. The cabinet lighting controller 218 can flash and vary lighting as desired. For example, cabinet edge lighting can change and flash in combination with music rhythms or in combination with game events. Other variations are possible.

In some embodiments, cabinet 104 may include LED strip lighting or LED rope lighting to accentuate the cabinet and enhance the attractiveness of gaming device 100 to players. LED rope lighting is a plurality of small light-emitting diode bulbs linked together and encased in a plastic, polyvinylchloride, or other suitable material to create a string of lights. For example, in the embodiment of FIG. 1, cabinet 104 includes cabinet accent lighting 140. In one embodiment, cabinet accent lighting 140 is LED rope lighting mounted flush with the front side edge of the cabinet side panels 108. The LED rope lighting can generate any of suitable colors, and are controlled by cabinet lighting controller 218 and a processor of gaming device 100 to selectively mix the emitted light colors in a manner to create any color in the same manner as the frame edge lighting.

In various embodiments, gaming device 100 includes one or more audio speakers and appropriate driving electronics and sound cards so that game players may experience pleasing audio aspects of the gaming device 100. Audio is desirable to attract and maintain player interest in gaming device 100. Gaming device 100 may also emit attraction sounds during any idle period of gaming device 100. Game audio may add to the player's enjoyment of gaming device 100 by providing music and sound effects designed to enhance and compliment the gaming experience.

Audio speaker hardware may include one or more speakers disposed in or on the cabinet 104 of gaming device 100. In FIG. 1, a pair of audio speakers 142 are shown mounted on the upper corners of second display frame 132. Any suitable number of additional speakers may be provided on additional display frames or on the lower cabinet body portion 106 as desired.

Speakers designed for emitting bass vibrations may be included in some embodiments. Speaker placement may be selected to enhance the sound emitting characteristics of the gaming device. For example, bass speakers or additional speakers 144 may be mounted inside lower cabinet body portion 106. Further, it is envisioned that in some embodiments sound processing such as multichannel processing and surround sound processing are included in gaming device 100. Audio jacks for attachment of player headphones may also be provided in some embodiments of gaming device 100 for the player to further enhance the audio experience of the game and also to block out noise from other gaming devices.

In one embodiment, front panel 110 of lower cabinet body portion 106 includes a locked removable panel or locked door (not shown), which can be opened for access to internal control system and technology components that are housed within lower cabinet body portion 106 (discussed hereinbelow with respect to FIG. 2). Front panel 110 may be flanked on vertical sides by cabinet side panel extensions 146 which serve to define a space below player interaction area 112 for players to place their feet and legs while they are playing gaming device 100 in a seated position. Foot rest 148, which may be cushioned, is provided below player interaction area 112 to enhance a player's ergonomic comfort while playing gaming device 100. In one embodiment, the edges of player interaction area 112 may be ergonomically cushioned as well.

Gaming device 100 may be embodied in alternative gaming device housing forms and styles. For example, the housing may have fewer or greater number of display areas for displaying the game and game-related information to the player. If multiple displays are used, the displays may be of similar size, shape, and orientation or the displays may be divergent from each other in one or more of their respective descriptive characteristics. The one or more displays can be supported by, mounted upon, or housed within a cabinet 104 which can comprise a variety of shapes, sizes, and forms. The cabinet 104 can 1) protect and house the operational electronics, 2) adequately support the display(s) in a position easily viewable for a seated or standing player, as necessary 3) provide an easy location and support for all necessary player input/output (I/O) interactions, including gaming control interactions and value wagering interactions. For example, in some embodiments the gaming device 100 may be disposed in a housing style referred to as a “slant top” gaming device that is designed to be operated with the player comfortably seated. In this arrangement, generally, the gaming display(s) and all player I/O controls are located on a low, wide, surface that extends forwardly from the player on a horizontal plane and then slopes upwardly and away from the player's seated location.

In one embodiment, housing styles of cabinet 104 of gaming device 100 may include bar top or table top housing arrangements. These housings are generally small enough to be placed on top of an existing bar or table while providing the requisite gaming device housing functions of protection of/access to gaming electronics, displays, and player I/O functions described above.

In one embodiment, cabinet 104 may be an embedded housing. Embedded housings are built into structures designed to otherwise function as bars or tables in a gaming environment. Displays may be integral with the bar top or table top surface or the entire unit may be contained below a transparent bar or table top surface while controls are disposed on the lower front or side of the bar or table.

Turning now to FIG. 2, the features and advantages of the gaming system described above will now be described in terms of the various technology components for allowing player interaction with the gaming device 100.

FIG. 2 illustrates a functional block diagram of an embodiment of technology components of gaming device 100 that are specially configured to carry out the game function and operations described herein. The functional elements shown in FIG. 2 cooperate, on a broad and general level, to function as gaming device 100. The subject matter and functional operations described in relation to FIG. 2 can be embodied in hardware, software, or a combination thereof. Described hardware includes the structures described and their functional or operational equivalents. Described functions may be performed by hardware, digital circuitry, computer software, computer firmware, or functionally equivalent combinations thereof.

In one embodiment, gaming device 100 is functionally controlled by control unit 200. Control unit 200 is specifically configured and functions to perform all aspects of operations for providing the game. Control unit 200 includes at least one specially configured processor and at least one controller configured to operate with at least one memory device and at least one data storage device, at least one input device, and at least one output device. In one embodiment, control unit is also configured to communicate with a server device through a network.

In one embodiment, control unit 200 includes at least one specially configured processor 202 or central processing unit (CPU). In one embodiment, specially configured processor 202 include arithmetic logic units and math co-processors also known as floating point units. In one embodiment, specially configured processor 202 includes registers for holding instructions or other data, and cache memory for storing data for faster operation thereupon. In one embodiment, specially configured processor 202 may be a multi-core processor that includes two or more processors for enhanced performance, more efficient parallel processing, or other advantageous computing functions. In another embodiment, specially configured processor 202 may be one or more processing devices such as microprocessor(s) or integrated circuit(s) and may include one or more controllers. It should be appreciated that in some embodiments, a general purpose processor could be programmed to perform the functions of specially configured processor 202.

A controller, in one embodiment, is a device or a software program that manages or directs the flow of data between two entities. Often, controllers are special purpose circuitry or software that solve a technical communications problem between different technology systems. In one embodiment, a controller functions as an interface between two systems while managing the communications between the systems. In another embodiment, a controller functions as an interface between a processor and a peripheral device and functions to control the peripheral device.

At least one specially configured processor 202 or controller of control unit 200 is specially configured to communicate with at least one memory device, generally shown as memory device 204 in FIG. 2. In one embodiment, memory device 204 includes one or more memory structures for storing instructions and various types of game data. Memory structures include one or more random access memory units (RAMs) units, one or more read only memory units (ROMs), one or more flash memory units including solid state drives (SSDs), one or more electrically erasable/programmable read only memory units (EEPROMs).

It should be appreciated that in one embodiment, communication with a memory device by a processor or a controller encompasses the processor or controller accessing the memory device, exchanging data with the memory device, or storing data to the memory device.

Memory device 204 may store all program code and game code (collectively the “code”), and operation data necessary for the operation of the gaming device 100 and execution of the gaming features described hereinbelow. In an alternative embodiment, game code and operation data necessary for the operation of the gaming device 100 may be store in a distributed manner such that some code is stored in memory device 204 and other code is stored remotely from gaming device 100. In one embodiment, the code and operation data necessary for the operation of the gaming device includes, for example, basic input and output function data, instruction fetching data, bus and network communication protocol data, and like data necessary for an operational gaming device 100. In one embodiment, the code and operation data necessary for the execution of the gaming features includes, for example, game image data, game rule data, pay table data, game mode and timing data, gaming value and wager parameter data, and random or pseudo-random number generation data.

In addition to the memory device 204 described above, in one embodiment, the code and operation data for the operation of the gaming device described above may be stored in removable game cartridges or flash drives, a compact disk ROM, a digital versatile disk (DVD) optical storage technology, or suitable other fixed non-transitory storage mediums. In another embodiment, part or all of the code and operational data for operation of the gaming device or for execution of the game features may be stored in a remote memory structure and be downloaded to the memory device 204 via a network connection.

In one embodiment, the gaming device 100 may utilize any combination of memory devices such as random access memory devices (RAMs), unalterable memory devices (ROMs), and mass storage devices for securely storing and securely communicating the software components or code that facilitate game play and other functions of the gaming device 100. The memory devices may store software components or code that include various game data and game related control and execution software. In some embodiments, the software components stored in the memory devices may include gaming system initialization software, system basic input and output software, operating system software, value acceptor software, value dispenser software, display image generation software, game symbol set image generation software, game rule execution software, game data set(s), random number generation software, system driver software, system data bus management software, audio generation and speaker driver software, and video generation and display driver software, and any other suitable software routines for operation of the gaming device 100.

In some embodiments, the memory devices, such as memory device 204, with the software components and other data may be secured and authenticated by authentication software stored in an unalterable memory device within the housing of gaming device 100. The gaming device 100 may also include application specific integrated circuits (ASICs) to perform the security and authentication functions. At any appropriate time, such as before each play of a game, at a predetermined interval, upon transfer of any game data or any software components from a mass storage to memory device 204, or upon demand, the gaming device 100 (using a processor such as processor 202 or a separate ASIC) may execute an authentication routine and perform an authentication of any software component or other data of the gaming device 100. In one embodiment, the gaming device software components may be prepared for authentication via creation and storage of an encrypted signature unique to one or more of the software components.

In one embodiment, an encrypted signature may be created by utilizing a hash function on a software component or code to form a message digest (i.e., a hash of the software component) followed by a key encryption of the message digest to form an encrypted signature unique to the software component. In some embodiments, the key encryption may be public key encryption, private key encryption, or any suitable key encryption schema. The encrypted signature may be stored with the gaming device software component, for example, in a mass storage device or an unalterable memory. During a software component authentication, the gaming device 100 executes one or more authentication routines utilizing the same hash function to operate on the software component to compute, or re-create, a new message digest for the software component. The new or re-created message digest may then be compared with a previously created message digest obtained by decrypting the stored encrypted signature. Matching message digests between the new and previously created message digests indicate that the software component is authentic and gaming device 100 may allow game play to proceed. However, when the message digests do not match, the gaming device 100 may determine that the software component under authentication may be corrupted or fraudulent and game play may be halted. It should be appreciated that the gaming device 100 may perform other suitable security and authentication checks on the game data or software components. Such authentication and security devices and functions are unique to gaming and casino industry to minimize or prevent fraud in gaming devices and gaming systems.

For a player to interact with gaming device 100, control unit 200 receives and processes player inputs, and control unit 200 causes processed results to be output or communicated to the player. In one embodiment, player inputs are recognized and processed or directed for processing by input/output (I/O) controller 206. Further, I/O controller 206 may process and direct player outputs for communication to the player. I/O controller 206 can function as the intermediary between the specially configured processor 202 and one or more input devices to control information and data flow therebetween. I/O controller 206 may also function as the intermediary between the specially configured processor 202 and one or more output devices to control information and data flow therebetween. I/O controller 206 is configured to understand the communication and operational details (such as hardware addresses) for each attached input device and output device. In this manner, specially configured processor 202 is freed from the operational details of the peripheral I/O devices. For example, in one embodiment where an input or output device is changed or upgraded, I/O controller 206 can be changed without changing other gaming system 100 components.

In one embodiment, a player deposits value into gaming device 100 by inserting some form of currency into a value acceptor 208 for game play. Alternatively, a player deposits value into gaming device 100 by inserting an encoded paper ticket into a value acceptor 208 for game play in one embodiment. Value acceptor 208 can be combined with a currency reader and validator, and a code reader for reading value encoded on paper tickets. Value acceptor 208 may read, validate and communicate the amount of the inserted value to the specially configured processor 202. Specially configured processor 202 can establish a gaming credit balance for the player based on the communication from the value acceptor 208. Specially configured processor 202 can also communicate the player's credit balance on a credit balance display of gaming device 100. During game play, each time a player risks a wager on an outcome, specially configured processor 202 processes the wage and determines the amount of credits to debit from the player's credit balance. When a winning outcome is obtained, specially configured processor 202 is configured to determine the amount of credits to add to the player's credit balance.

As previously mentioned with respect to FIG. 1, a variety of value acceptance arrangements are possible. In one embodiment, the value acceptor 208 could include magnetic strip or chip card readers to accept and transfer value. Value acceptor 208 may also be configured to accept and transfer non-traditional currencies such as digital currencies. In these embodiments, I/O controller 206, a specially configured processor 202, or both contain appropriate control instructions to communicate and extract value from the inserted item containing value. In one embodiment, use of a magnetic strip or embedded chip card, for example a bank card, for value insertion requires specially configured processor 202 to communicate, via network interface controller 224 (described below), with devices external to the gaming device 100.

In one embodiment, card reader 210 may be included in gaming device 100 to accept player loyalty cards. For example, card reader 210 can extract account identifying information from the card and utilizes this information to access the associated account information stored remotely via network interface controller 224. In embodiments where player loyalty/player tracking systems are employed, a player's loyalty account and record of gaming activity can be stored in a networked storage location or database. Specially configured processor 202 is configured to record the player's gaming activity in memory device 204 during the duration of loyalty card insertion. When the loyalty card is removed from card reader 210, recorded gaming activity is uploaded, via network interface controller 224, to the remote storage location associated with the player's account. In this manner, the player's gaming activity can be further processed and analyzed, and the player can be awarded loyalty rewards based upon his activity data.

In various embodiments, player control 212 receives a player's game inputs and communicates the player's game inputs to specially configured processor 202. The player's game inputs may include, but are not limited to, wager amounts, pay line selections, game control signals, and cash-out signals. The player control 212 may generate signals based on button presses, touch screen activations, or voice control. The player initiated signals are propagated to the specially configured processor 202 by I/O controller 206. Further, the player initiated signals may direct and inform execution of the game instructions stored in memory device 204 and configured to be executed by specially configured processor 202.

In one embodiment, specially configured processor 202 is configured to execute stored program code and instructions which generate random numbers or pseudo-random numbers. In one embodiment, as illustrated in FIG. 2, a random number generator (RNG) 214 is a software module configured to be executed by specially configured processor 202 for the generation of a true random or pseudo-random number. The code for RNG 214 may be stored in memory device 204. RNG 214 generates random numbers for use by the gaming software during game execution. In one embodiment, random numbers are utilized by game software for the random selection of one or more game symbols from a set of game symbols during a game. As a non-limiting example, the set of game symbols can include numbers, letters, geometric figures, symbols, images, character, animations, blank symbols (e.g., the absence of symbols), or any other suitable graphical depiction. In various embodiments, once random symbols are selected based upon the random number generated by RNG 214, patterns of symbols are compared to determine wagering outcomes. In an alternative embodiment, gaming device 100 may include a hardware based random number generator that is in communication with specially configured processor 202 to supply random numbers for game generation purposes. The hardware based random number generator may be incorporated into specially configured processor 202 or can be separate from specially configured processor 202.

In yet another embodiment, random generation of “numbers” or symbols may be performed with electro-mechanical components. For example, gaming devices such as gaming device 100 may incorporate a plurality of mechanical reels rotatable about a common axis. A plurality of indicia or symbols may be positioned around the periphery of the plurality of reels. Each of the indicia or symbols on each reel may indicate separate detectable reel stop positions. The reels can be set into a spinning/rotation motion by pulling a lever or pushing a button. In some embodiments, the gaming device 100 can stop the reels by the gaming device 100 actuating, on a random timing basis, a suitable mechanical or electro-mechanical reel brake. When the reels stop rotating, one or more displayed stop positions of each reel is detected. Since the stop positions are each associated with an indicia or symbol, the gaming device can determine whether the combination of stop positions (i.e., translating to a combination of displayed symbols) results in a winning symbol combination.

Returning to FIG. 2, control unit 200 controls the function and output of a plurality of output devices utilized by gaming device 100. In various embodiments, I/O controller 206 serves as an interface unit between specially configured processor 202 and output devices such as video processor 216, cabinet lighting controller 218, audio controller 220, and value dispenser 222.

In one embodiment, video processor 216 communicates with specially configured processor 202 to render all game graphics, video displays, and information on gaming device 100's one or more video display units. In one embodiment, video processor 216 includes one or more processors, controllers, and/or graphics cards for processing the game images, outcomes, and animated displays and coordinating the processed data to be display between, among, or across any or all display devices. In various embodiments, this may include being configured to simulate objects and the movement of objects which represent video reels containing sets of gaming symbols.

It should be appreciated that in certain other embodiments where physical mechanical reels are utilized by the gaming device 100 as a game displays, reel controllers and stepper motors would be provided in lieu of or in addition to video processor 216.

In embodiments which utilize cabinet lighting as described with respect to FIG. 1, a cabinet lighting controller 218 may be utilized to coordinate and control the color and timing of cabinet lighting displays with specially configured processor 202. In certain embodiments which utilize sound design, specially configured processor 202 may utilize audio controller 220 to coordinate and control the sound emissions. In one embodiment, audio controller 220 may include one or more audio processing cards for generating sound and for driving the one, two or more speakers that may be included with gaming device 100.

In various embodiments, players may collect remaining credit value by initiating a signal via player control 212 which is communicated to specially configured processor 202 via I/O controller 206. The signal triggers a readout of the player's credit amount and specially configured processor 202 initiates a value dispensing signal which, in turn, is communicated to value dispenser 222. In one embodiment, value dispenser 222 can be controlled to issue the player's credit value using any of the types of value discussed herein. In some embodiments, the player's credit value may be issued to the player via a printed and dispensed encoded paper ticket or token which the player can then exchange at a special purpose kiosk or cashier location for the monetary value encoded into the ticket or token. In some embodiments, the specially configured processor 202 can direct the value dispenser 222 to issue to the player an appropriate amount of coin or bills directly to the player. Additionally, or alternatively, in some embodiments, the player may have the option to electronically direct the credit value to an account associated with the player.

In some embodiments, control unit 200 of gaming device 100 may communicate with one or more devices outside the gaming device 100. For example, gaming device 100 may be connected to a larger gaming network via a local area network (LAN) or a wide area network (WAN). Control unit 200 may communicate with one or more central servers, controllers, or remote devices to execute games, establish credit balances, participate in jackpots, etc. In such embodiments, network communications and connections are accomplished via a network interface controller 224. Network interface controller 224 can be a digital circuit board or card installed in control unit 200 to provide network communications with external devices.

In some embodiments, various additional features and functions are performed by control unit 200. For example, control unit 200 may be specially configured with appropriate software to track all game play events that occur on gaming device 100. In some embodiments, control unit 200 may audit all recorded monetary transactions, including all wager amounts, game outcomes, game winnings, and game payouts that occur through gaming device 100. Further, some embodiments may include security software to assist in protecting the gaming device 100 from tamper or alteration attempts.

### Gaming System Operation

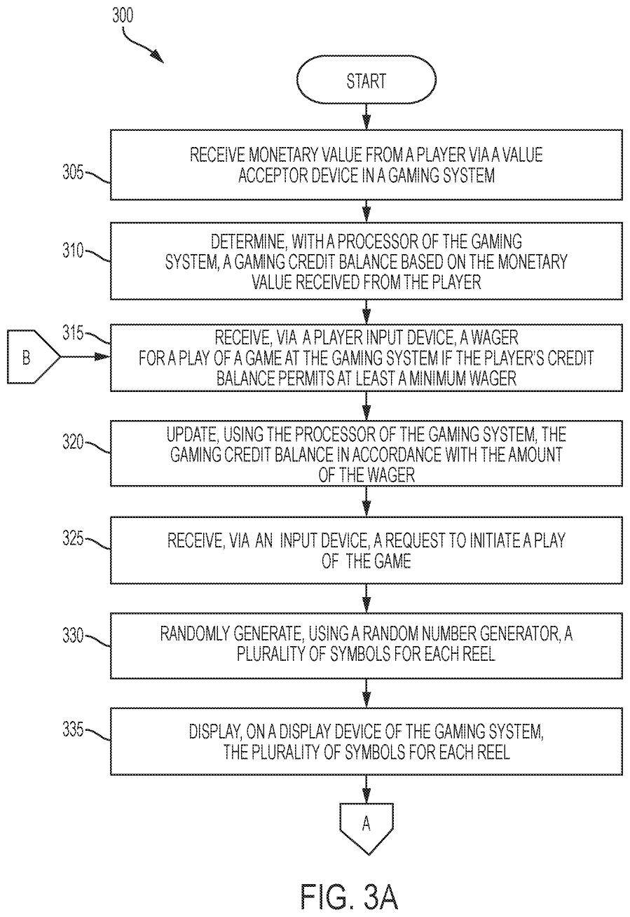

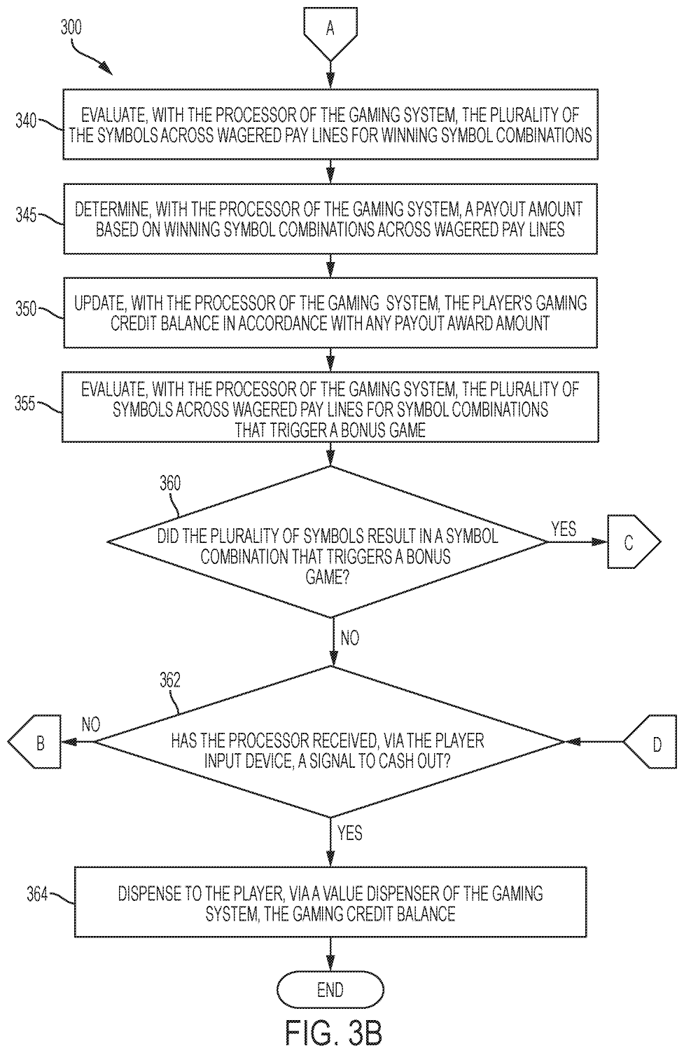

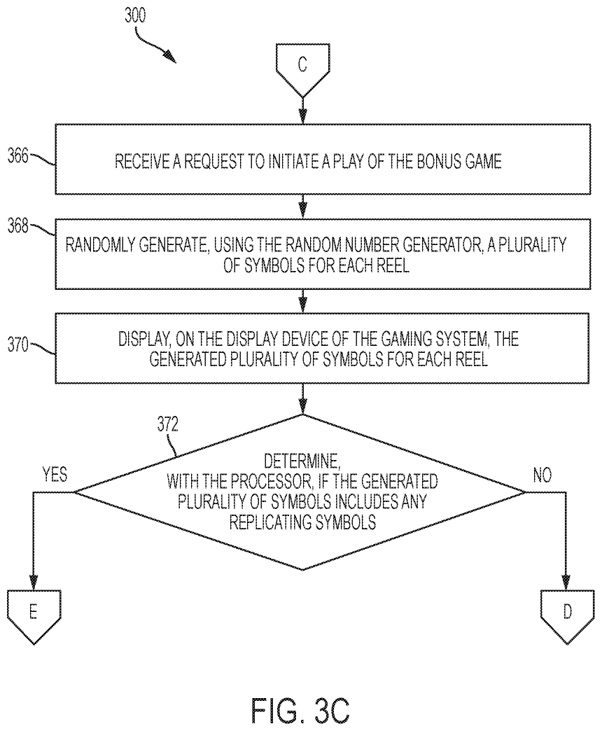

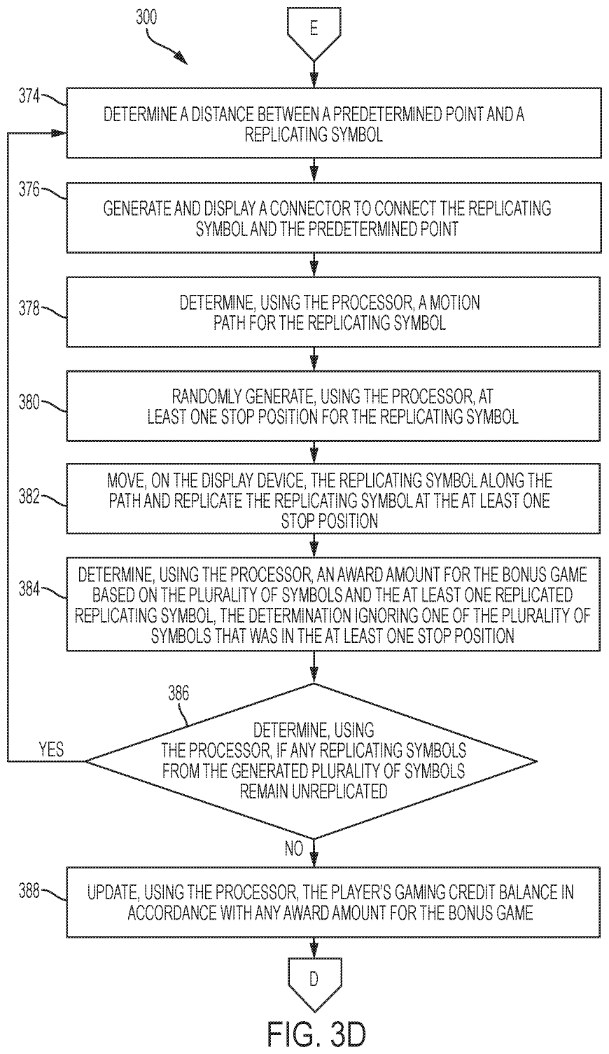

FIGS. 3A, 3B, 3C, and 3D illustrate a flowchart of an example operation 300 of one embodiment of the gaming system and method. FIGS. 3A and 3B are depicted as a base or primary game while FIGS. 3C and 3D are depicted as a bonus game. However, it should be appreciated that FIGS. 3C and 3D may be integrated as part of a base game without entering a separate bonus game. FIGS. 3C and 3D may be used in a standalone base game.

In one embodiment, a processor of the gaming system is configured, via instructions stored in a memory device, to perform the operation 300. However, it should be appreciated that other suitable variations of operation 300 are possible. For example, in one embodiment, fewer or one or more additional blocks (not shown) may be employed in operation 300 of the gaming system and method. In other embodiments, the blocks may be performed in any suitable order.

FIG. 3A illustrates one embodiment in which the gaming system receives a monetary value from a player to initiate operation 300. As indicated in block 305, the gaming system may receive monetary value via a value acceptor device associated with the gaming system. The value acceptor device, in one embodiment, is disposed in a gaming system or in communication with the gaming system as discussed above.

In one embodiment, the gaming system determines a credit balance based on the monetary value received from the player at a value acceptor device as indicated in block 310. The gaming system determines, via a processor, a gaming credit balance for the player. The gaming credit balance may be based on the monetary value received from the player at the value acceptor device.

In one embodiment, the gaming system may receive a wager for a play of a game at the gaming system. Block 315 of FIG. 3A illustrates one embodiment where the player's wager is received via a player input device. The gaming system may allow a player to place a minimum wager, a maximum wager, or any suitable wager amount. Depending on the wager amount, the gaming system may also enable the player to select pay lines across displayed symbol positions (e.g., symbol display areas) on reels in a game in which to place wagers. Although in some embodiments, the gaming system selects the wagered pay lines automatically based on the player's wager. Wagered pay lines may be referred to herein as active pay lines. In one embodiment, the gaming system may determine whether the player provided enough credits to enable the player's selected wager. The gaming system may prevent the player from placing the wager and starting a play of a game if the player's credit balance is not large enough to support the player's selected wager. If enough credits are not available in the player's credit balance, the gaming system enables the player to insert additional value to obtain the minimum credit level or to cash out of the gaming system.

In one embodiment, the gaming system may use a processor of the gaming system to update a gaming credit balance. The credit balance may be updated in accordance with the player's wager amount as indicated in block 320. In some embodiments, the credit balance is not updated until a later time.

Block 325 illustrates one embodiment in which the gaming system may receive a request to initiate a play of a game. The request to initiate the play of the game may be received from a player via a player input device in communication with the gaming system. The gaming system may securely access game data from a memory device and execute an authentication routine on the game data to start a play of a game as discussed above. For example, the player may press a spin button on the gaming system to start spinning slot machine reels of the gaming system (or randomly generating symbols using other methods discussed above for virtual reels) for the play of the game. It should be appreciated that reels used throughout the specification may refer to mechanical reels, electro-mechanical reels, or virtual video reels (where virtual reels strips or no reel strips are used). It should further be appreciated that although many examples illustrated in the specification describe the games in terms of slot machines with reels, other games may be used, including games without slot machine reels.

In one embodiment, the gaming system may use a random number generator to randomly generate a plurality of symbols from a plurality of symbol sets as indicated in block 330. In some embodiments, the gaming system may generate the plurality of symbols for display on a set of reels (or virtual reels). In some such embodiments, each reel is associated with its own set of symbols. As used herein, the random number generation may refer to pseudo-random or true-random number generation depending on the module used for the random number generation.

In one embodiment, the gaming system may cause a display device to display the plurality of symbols generated as indicated in block 335. In a game using reels, the gaming system may display the generated plurality of symbols in visible symbol display areas of each of the reels. Off page connector A refers to FIG. 3B to continue operation 300.

Turning now to FIG. 3B and off page connector A, in one embodiment as shown in block 340, the gaming system evaluates the generated plurality of symbols across active or wagered pay lines for winning symbol combinations. In some embodiments, the gaming system evaluates the winning symbol combinations based on the pay lines wagered upon by a player. The gaming system may evaluate the player selected pay lines, gaming system assigned pay lines, or pay lines assigned as active in some other manner for the play of the game. In one embodiment using reels, the gaming system determines an award amount based on winning symbol combinations formed across the reels on active pay lines. For example, if a pay table associated with the gaming system indicated that at least three of the same bar symbols is a winning symbol combination and awards a predetermined payout, the gaming system would evaluate the generated plurality of symbols for bar symbols. If the gaming system generated at least three bar symbols on adjacent reels and along an active pay line, the gaming system may determine that the three bar symbols is a winning symbol combination based on the predetermined pay table. It should be appreciated that a pay table may include any suitable number of winning symbol combinations and payouts. In one embodiment, a pay table may indicate that as few as one symbol may be associated with a payout. Alternatively, two or more symbols may be used to form winning symbol combinations that result in a payout.

In block 345, the gaming system determines, with the processor, a payout amount based on the evaluated winning symbol combinations across wagered pay lines. As illustrated in block 350, the gaming system may update, with the processor, the player's gaming credit balance in accordance with any award amount. As noted above, the blocks illustrated in FIGS. 3A-3D can be rearranged in any suitable order. As such, it should be appreciated that the gaming system may update player's gaming credit balance at other suitable times.

In one embodiment, as indicated in block 355, the gaming system evaluates the plurality of symbols across wagered pay lines for symbol combinations that trigger a bonus game with a predetermined quantity of spins (or activations, where the bonus game does not use slot reels). In some embodiments the symbol or symbol combinations that trigger the bonus game do not need to appear on wagered pay lines. In some embodiments, the predetermined quantity of spins are provided as free spins. In other embodiments, the player may pay to obtain the predetermined quantity of spins. It should also be appreciated that in some embodiments, events other than generating one or more of a predetermined symbol may trigger the bonus game. If the gaming system determined that the generated plurality of symbols did not result in triggering a bonus game, in block 360, operation 300 moves to block 362. In one embodiment, as indicated in block 362, the gaming system may receive a signal to end game play or “cash out” via an input device of the gaming system. In such a situation, the gaming system dispenses a value to the player, through a value dispenser, based on the player's gaming credit balance as illustrated in block 364 and operation 300 ends.

On the other hand, if the gaming system processor has not received a signal to end game play via the player input device, the process of operation 300 returns to block 315 via off page connector B. The gaming system may receive, via a player input device, a wager for another play of the game and continue operation 300 from block 315. However, in one embodiment, the wager may not be accepted if the player has fewer credits than the player's selected wager amount as shown in block 315.

Returning now to block 360, if the gaming system determined that the generated plurality of symbols resulted in trigging a bonus game, operation 300 moves to block 366 in FIG. 3C via off page connector C. In one embodiment, if the gaming system determines that the generated plurality of symbols includes one or more generated predetermined symbols, the gaming system will trigger or activate the bonus game. In one embodiment, the predetermined symbol is a symbol that serves one function: to trigger the bonus game. In alternative embodiments, the predetermined symbol serves a plurality of game functions, such as triggering the bonus game and providing an award value. Other suitable game functions may be associated with the predetermined symbol.

The request to initiate the play of the bonus game may be received from a player via a player input device in communication with the gaming system. The gaming system may securely access game data from a memory device and execute an authentication routine on the game data to start a play of the bonus game as discussed above. For example, the player may press a spin button on the gaming system to start spinning slot machine reels of the gaming system (or randomly generating symbols using other methods discussed above for virtual reels) for the play of the bonus game. It should further be appreciated that although the examples illustrated in the specification describe the games in terms of slot machines with reels, other games may be used, including games without slot machine reels.

In some embodiments, the gaming system alters the play of the game during the bonus game. In some embodiments, the gaming system may change how symbols operate. In some embodiments, the gaming system may use different pay tables in the bonus game to calculate winning symbol combinations. In some embodiments, the gaming system may use the same pay tables in the base game and the bonus game to calculate winning symbol combinations. In some embodiments, the bonus game can be a similar game to the base game. In some embodiments, the bonus game is a video slot reel game with a plurality of slot reels.

Returning to block 366 of FIG. 3C, block 366 illustrates one embodiment in which the gaming system may receive a request to initiate a play of the bonus game. It should be appreciated that each play of the bonus game corresponds to one of the awarded predetermined quantity of spins for the bonus game in one embodiment. It should also be appreciated that each play of the bonus game may occur within a play of the game (e.g., the play of the game is a combination of the base game and the bonus game). As noted above, the features discussed in connection FIG. 3C and FIG. 3D may also be applied to primary games or games that are not bonus games. The request to initiate the play of the bonus game may be received from a player via a player input device in communication with the gaming system. For example, the player may press a spin button on the gaming system to start randomly generating symbols for the play of the bonus game. In an alternative embodiment, the processor of the gaming system may automatically initiate the play of the bonus game and randomly generate symbols for the play of the game.

In one embodiment, the gaming system uses a random number generator in conjunction with the processor to randomly generate a plurality of symbols from one or more bonus symbol sets for the bonus game as indicated in block 368 (for a spin of the bonus game). In some embodiments, the bonus symbol sets comprise one or more symbols that are different from the symbols from the primary game's symbol sets. In some embodiments, the bonus symbol sets comprise the same symbols from the primary game's symbol sets. For some embodiments without a bonus game, the gaming system randomly generates the plurality of symbols from one or more second symbol sets. In some embodiments without a bonus game, the gaming system randomly generates the plurality of symbols from the same set, but may activate features associated with particular symbols, such as features associated with the replicating symbols.

In some embodiments, the gaming system designates at least one symbol in at least one of the bonus symbol sets as a replicating symbol for the bonus game. In some embodiments, the gaming system designates at least one symbol in each of the bonus symbol sets as a replicating symbol during the bonus game. It should be appreciated that the gaming system may designate any number of symbols in the bonus symbol sets as replicating symbols. In some embodiments, the replicating symbol is the same symbol as the predetermined symbol to trigger a bonus game. In other embodiments, the replicating symbol is different from the predetermined symbol to trigger a bonus game. In some embodiments, the replicating symbol is replicated during a play of the game, where the replicated replicating symbol is used in evaluating symbol combinations for winning symbol combinations. In some embodiments, the replicating symbol is used in place of another generated and displayed symbol.

In some embodiments, the replicating symbol is a wild symbol. In some embodiments, a wild symbol, is a type of symbol that can mimic or substitute for almost any symbol that a gaming system uses. For example, if the gaming system generates a wild symbol alongside other symbols, the gaming system may evaluate the wild symbol like one of the other symbols generated along a wagered pay line for purposes of determining a winning symbol combination in one embodiment. As a specific example, if the gaming system generates a wild symbol alongside two Cherry symbols along a wagered pay line, the gaming system may evaluate the wild symbol as a Cherry symbol for purposes of determining whether the wild symbol and the two cherry symbols form a winning symbol combination of three Cherry symbols.

In some embodiments, the replicating symbol is a pay symbol. In some embodiments, the replicating symbol is a blank symbol. It should be appreciated that any suitable symbol in the bonus symbol sets for the bonus game can be designated as a replicating symbol.

In one embodiment, the gaming system may cause a display device to display the plurality of symbols generated as indicated in block 370. In a bonus game using reels, the gaming system may display the generated plurality of symbols in visible symbol display areas of each of the reels.

The gaming system determines, with the processor of the gaming system, whether the generated plurality of symbols included any replicating symbols as indicated in block 372. In one embodiment, if the gaming system determines that the generated plurality of symbols do not include any replicating symbols, the gaming system moves to off-page connector D and returns to block 362 in FIG. 3C. In some embodiments, the gaming system may repeat blocks 368-372 when the bonus game includes a plurality of spins or activations (not shown). In some such embodiments, the gaming system may repeat blocks 368-372 until no bonus spins or activations remain.

In one embodiment, as indicated in block 362, the gaming system may receive a signal to end game play or “cash out” via an input device of the gaming system. In such a situation, the gaming system dispenses a value to the player, through a value dispenser, based on the player's gaming credit balance as illustrated in block 364 and operation 300 ends. On the other hand, if the gaming system processor has not received a signal to end game play via the player input device, the process of operation 300 returns to block 315 via off page connector B. The gaming system may receive, via a player input device, a wager for another play of the game and continue operation 300 from block 315. However, in one embodiment, the wager may not be accepted if the player has fewer credits than the player's selected wager amount as shown in block 315.

Returning to block 372, if the gaming system determines that the generated plurality of symbols includes at least one replicating symbol, the gaming system moves to block 374 in FIG. 3D via off-page connector E. For each generated replicating symbol, the gaming system may copy (i.e., replicate) the replicating symbol in the bonus game in some embodiments.

At block 374, the gaming system determines with the processor, a distance between a predetermined point displayed in the bonus game and a replicating symbol in some embodiments. In some embodiments, the predetermined point is an anchor that is displayed throughout the bonus game. In some embodiments, the predetermined point is an anchor that is displayed after the gaming system determines that a replicating symbol was generated. In some embodiments, the gaming system includes a plurality of predetermined points. In embodiments with a plurality of predetermined points, the gaming system may randomly determine which of the predetermined points to use to measure the distance. It should be appreciated that the predetermined point can be represented by any object (e.g., a wall anchor, a hook on the wall anchor, a hook, a nail, a post, a pole, etc.) that can be used for connecting to another object (e.g., a rope, chain, etc.).

In one embodiment, as illustrated in block 376, the gaming system generates and displays a connector connecting the replicating symbol and the predetermined point. In some embodiments, the connector can be a rope, chain, a wire, or any other suitable object for connecting a replicating symbol to the predetermined point. In some embodiments, the gaming system generates a connecting point on the replicating symbol that is used to connect to the connector. The gaming system also determines a length of the connector based on the determined distance between the predetermined point and the replicating symbol in some embodiments.

As illustrated in block 378, the gaming system determines with the processor, a path of motion for the replicating symbol in some embodiments. In some embodiments, the path has a start point and end point. In some embodiments, the start point and the end point of the path are different points. In alternative embodiments, the start point and the end point of the path are the same point. In some embodiments, the gaming system determines the path of motion for the replicating symbol based on the predetermined point, the position of the replicating symbol, and the connector connecting the replicating symbol to the predetermined point. In some embodiments where the predetermined point is fixed, the connector and replicating symbols will pivot around the fixed predetermined point, creating an arc path that is based on the length of the connector. In some embodiments where the predetermined point is fixed, the arc path is a full circular path. In some embodiments with the full circular path, when the replicating symbol is moving around the circular path, the gaming system may spin the replicating symbol very fast and generate a wheel divided into slices. The wheel slices are each associated with an award. The gaming system may randomly determine one of the wheel slices to award to the player as part of the bonus game.

In some embodiments, the predetermined point is movable across the display of the gaming system. In some such embodiments, the motion of the predetermined point is linear and substantially horizontal, such that the path of the replicating symbol is linear and substantially horizontal. In some embodiments, the connector can be (e.g., a chain) reeled in or wrapped around the predetermined point to move the replicating symbol in a vertical direction. The gaming system can use other suitable variations to determine the path. It should be appreciated that the path for the replicating symbol can also use some suitable combination of the above to determine the path for the replicating symbol.

In some embodiments, physical properties of objects in the bonus game are not used to determine the path of the replicating symbol. For example, the physical properties of the generated connector are not used to determine the path in some embodiments. In some example embodiments, whether the connector is a chain with no elastic properties or a rope that typically has elastic properties, the gaming system may ignore these physical attributes when determining the path. On the other hand, in some embodiments, physical properties can be associated with certain objects in the bonus game to determine the path. For example, if the gaming system used a rope as the connector, the elasticity of the rope may cause the gaming system to determine a path that is different from a path if the connector was a chain with less elasticity. In some embodiments, the connector and the length of the connector is not used to determine the path. In some embodiments, the path for the replicating symbol is predetermined. In some embodiments, the path for the replicating symbol is randomly determined from a set of predetermined paths.

As illustrated in block 380, in some embodiments, the gaming system randomly generates, using the processor in conjunction with the random number generator, at least one stop position for the replicating symbol along the determined path. In some embodiments, a stop position corresponds to one of the symbol display areas. In some embodiments, the gaming system may use the at least one stop position along the determined path as a position to place the replicating symbol or a copy of the replicating symbol (e.g., where the replicating symbol is replicated). In some embodiments, the at least one stop position is determined before the replicating symbol is moved along the path as illustrated in block 382. In other embodiments, the at least one stop position is determined while the replicating symbol is moved along the path (not illustrated). In some embodiments, the gaming system generates a plurality of stop positions for the replicating symbol. In some embodiments with a plurality of stop positions, the gaming system places the replicating symbol or a copy of the replicating symbol at each of the plurality of stop positions. In alternative embodiments with a plurality of stop positions, the gaming system randomly determines one or more of the plurality of stop positions to place the replicating symbol or a copy of the replicating symbol.

In one embodiment, as illustrated in block 382, the gaming system moves the replicating symbol on the display along the determined path and generates a copy of the replicating symbol at the at least one stop position. In one such embodiment, the gaming system removes the replicating symbol from its current position on the display and moves the replicating symbol along the determined path and eventually generates the copy of the replicating symbol at the at least one stop position. In some embodiments, the connector is connected to the replicating symbol and therefore moves with the replicating symbol. In some embodiments, gaming system moves the replicating symbol from the start point of the path to the end point of the path at least once, then moves the replicating symbol in reverse (from the end point of the path to the start point of the path). In some embodiments, the gaming system reverses the movement of the replicating symbol at any suitable point along the path. In some embodiments, the gaming system moves the replicating symbol from the start point of the path to the end point of the path a plurality of times. In some embodiments, after a predetermined period of time and while the replicating symbol is moving along the path, the gaming system makes a copy of the replicating symbol and places the copy of the replicating symbol at the at least one stop position. In some embodiments, the at least one stop position is a symbol display area that includes a symbol from the generated plurality of symbols for the bonus game. In some embodiments, the copy of the replicating symbol covers the symbol from the generated plurality symbols that is in the same symbol display area. In some embodiments, the copy of the replicating symbol replaces the symbol from the generated plurality of symbols that is in the same symbol display area (e.g., the at least one stop position). In some embodiments, once the copy of the replicating symbol is placed in the stop position, the gaming system returns the replicating symbol to its originally displayed position.

In one embodiment, rather than removing the replicating symbol from its current position in the display, the gaming system keeps the replicating symbol in its current position in the display and makes a copy the replicating symbol (e.g., replicates the replicating symbol). In such an embodiment, the gaming system moves the copy of the replicating symbol along the path as noted above. In some embodiments, after a predetermined period of time, while the copy of the replicating symbol is moving along the path, the gaming system places the copy of the replicating symbol at the at least one stop position. In some embodiments, the at least one stop position is a symbol display area that includes a symbol from the generated plurality of symbols for the bonus game. In some embodiments, the copy of the replicating symbol covers the symbol from the generated plurality symbols that is in the same symbol display area. In some embodiments, the copy of the replicating symbol replaces the symbol from the generated plurality of symbols that is in the same symbol display area.

In one embodiment, illustrated in block 384, the gaming system determines an award amount for the bonus game based on certain of the generated plurality symbols and the copy of the replicating symbol. The determination includes, in some embodiments, an evaluation of certain ones of the generated plurality symbols and the copy of the replicating symbol for winning symbol combinations. In one embodiment, the determination of the award amount does not include an evaluation of the symbol of the generated plurality of symbols that is in the same symbol display area as the copy of the replicating symbol. In another embodiment, the determination of the award amount may include an evaluation of all the generated plurality of symbols and a second evaluation of certain of the generated plurality of symbols and the copy of the replicating symbol, where the second evaluation ignores the symbol of the generated plurality of symbols that is in the same symbol display area as the copy of the replicating symbol.

In block 386, the gaming system determines if any replicating symbols from the generated plurality of symbols remain unreplicated in one embodiment. In other words, in some embodiments, the gaming system may generate a plurality of replicating symbols. In one such embodiment, the gaming system excludes any copy of a replicating symbol in such a determination. Thus, in some embodiments, the gaming system does not perform blocks 374-386 for any copy of a replicating symbol. In alternative embodiments, the gaming system performs blocks 374-386 for any displayed replicating symbol (including any copies of replicating symbols). If the gaming system determines that a replicating symbol from the generated plurality symbols remains unreplicated as illustrated in block 386, the gaming system returns to block 374 for the unreplicated replicating symbol. In some embodiments where the gaming system generated a plurality of replicating symbols, gaming system may perform blocks 374-386 on more than one of the replicating symbols in parallel.

On the other hand, if the gaming system determines that no replicating symbols remain unreplicated, the gaming system moves to block 388. In block 388, the gaming system, using the processor, updates the player's gaming credit balance in accordance with any award amount for the bonus game and may proceed to off page connector D and return to block 362 in FIG. 3B.

As indicated in block 362, the gaming system may receive a signal to end game play or “cash out” via an input device of the gaming system. In such a situation, as illustrated in block 364, the gaming system dispenses a value to the player through a value dispenser based on the player's gaming credit balance and operation 300 ends.

On the other hand, if the gaming system processor has not received a signal to end game play via the player input device, the process of operation 300 returns to block 315 via off page connector B. The gaming system may receive, via a player input device, a wager for another play of the game and continue operation 300 from block 315. However, in one embodiment, the wager may not be accepted if the player has fewer credits than the player's selected wager amount as shown in block 315.

In some embodiments, the originally displayed position of a replicating symbol may determine a direction that the replicating symbol will move along the determined path. For example, if a replicating symbol was generated on a left-hand side of the display of the gaming system, the gaming system may move the replicating symbol (or a copy of the replicating symbol) from left to right along the determined path. As an alternative example, if a replicating symbol was generated on a right-hand side of the display of the gaming system, the gaming system may move the replicating symbol (or copy of the replicating symbol) from right to left along the determined path. In some embodiments, the gaming system randomly determines which direction along the path replicating symbol may initially move.

In one embodiment, where the plurality of symbols generated for the bonus game are displayed on video slot machine reels, when a replicating symbol is displayed on one of the reels, the gaming system determines a path that extends across all of the plurality of reels.

In one embodiment, if the gaming system places a copy of the replicating symbol at a stop position that already includes a replicating symbol, gaming system evaluates the copy of the replicating symbol as a multiplier for any determined awards.

In some embodiments, a plurality of gaming systems can be linked together, form a path across the plurality of gaming systems, and display the replicating symbol moving across the plurality of gaming system to alter an outcome of a game on one or more of the gaming systems. For example, if one of the plurality gaming systems generates a replicating symbol, one or more of the gaming systems may determine a path for the replicating symbol that moves across two or more of the plurality of linked gaming systems. Thus, in some such embodiments, the replicating symbol generated on one of the plurality of linked gaming systems may create a benefit for a different one of the plurality of linked gaming systems.

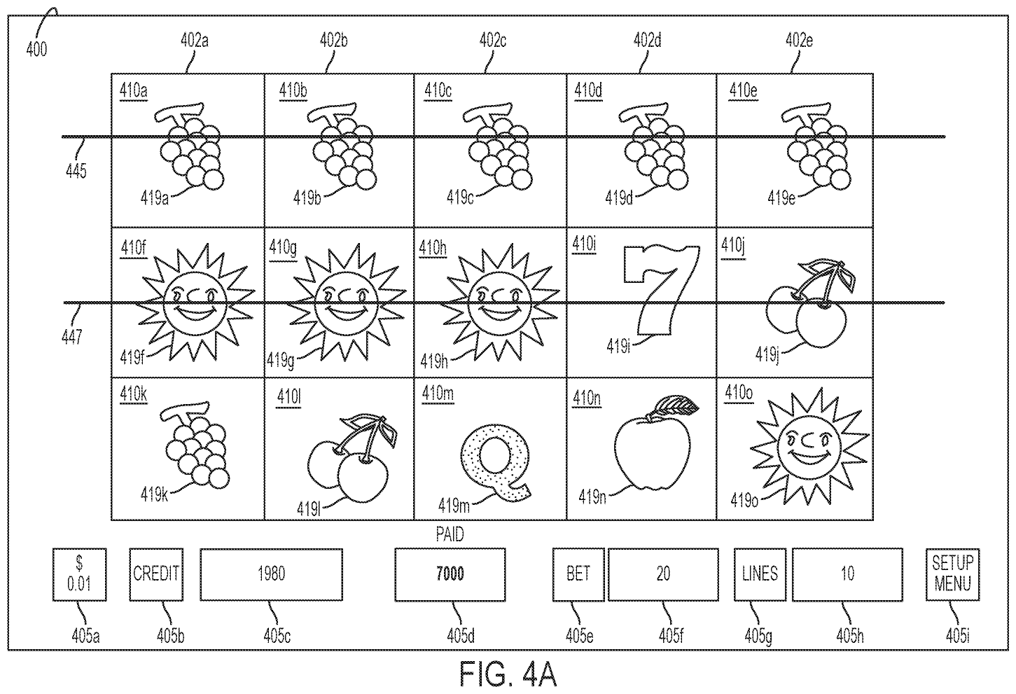

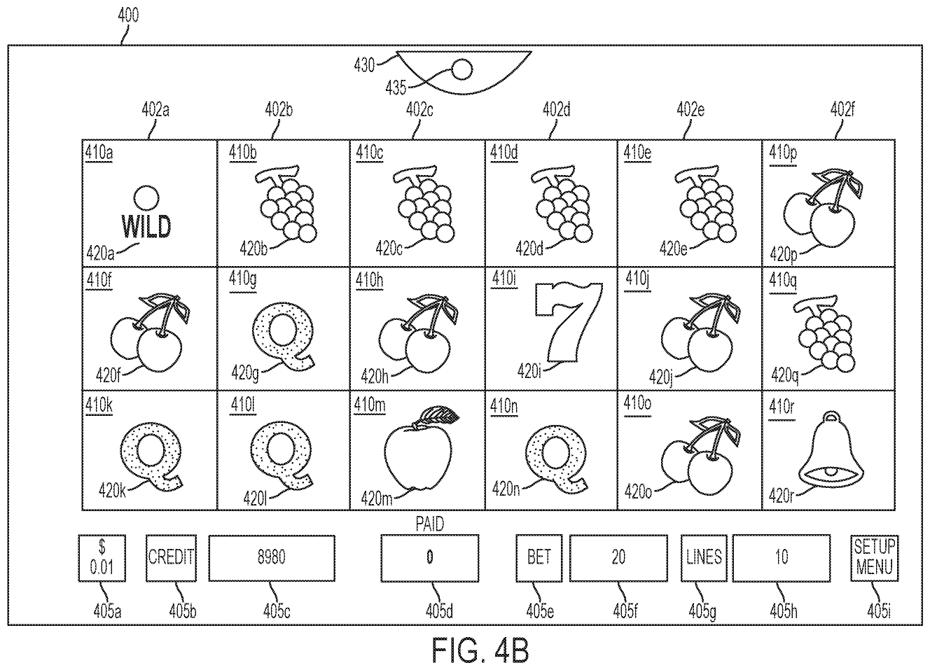

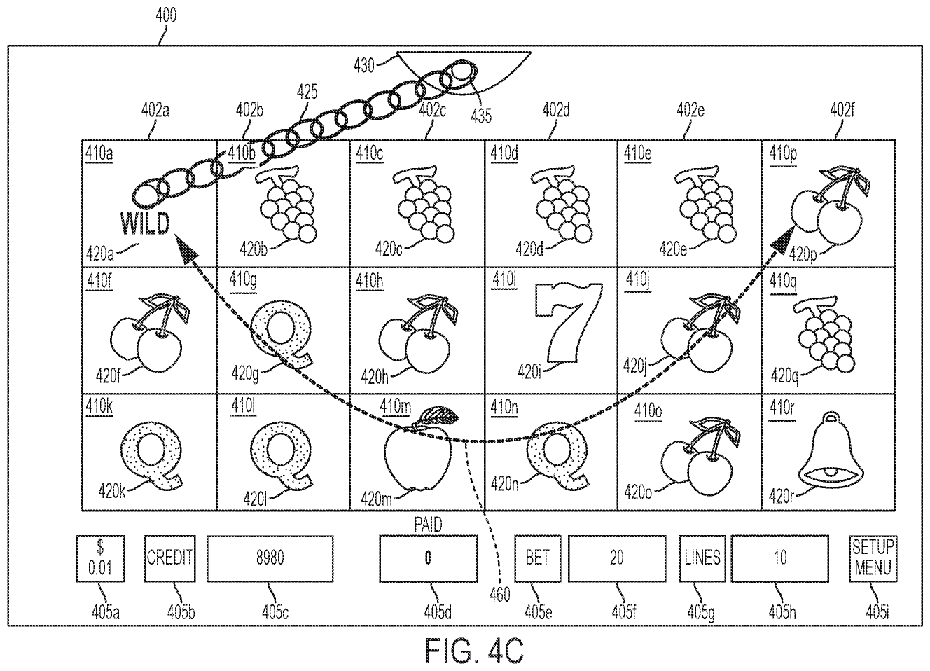

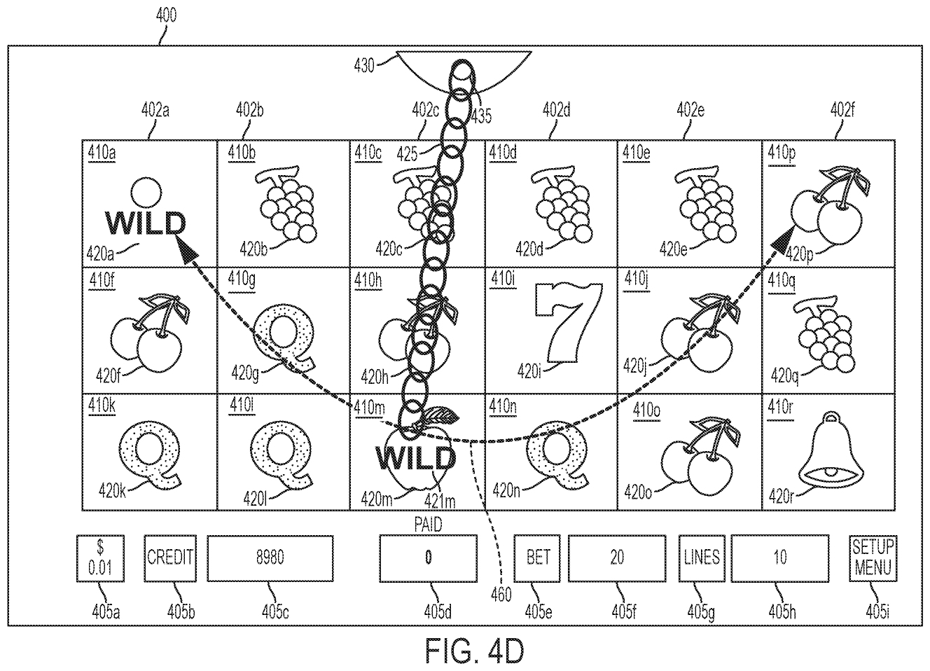

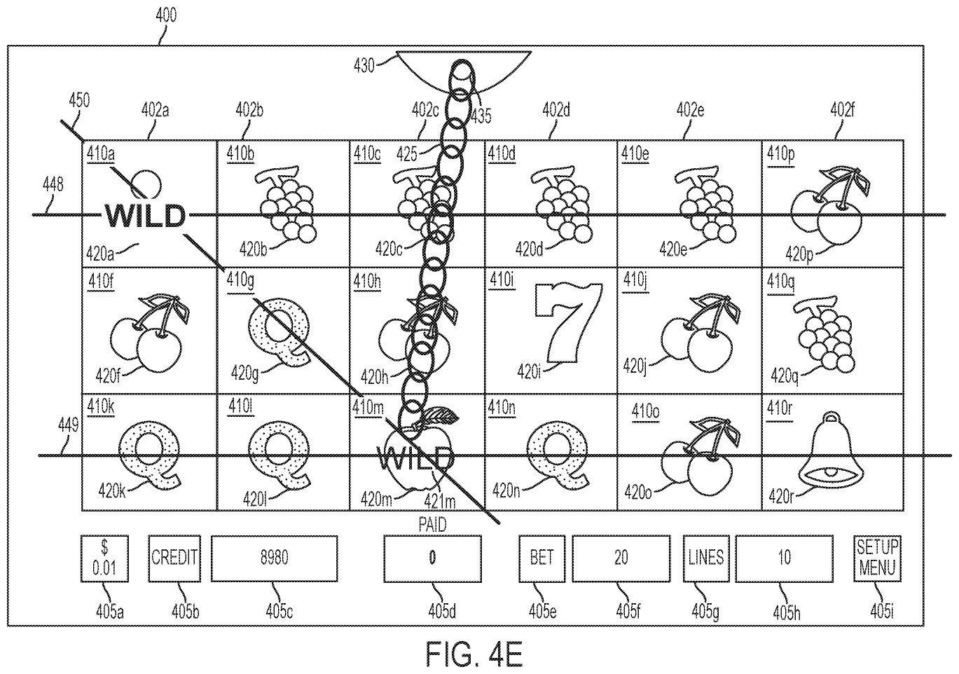

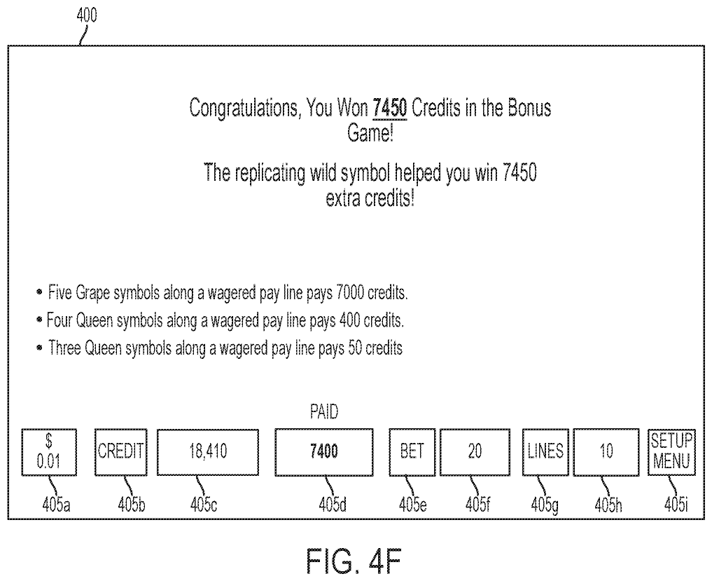

FIGS. 4A-4F illustrate screen shots of one embodiment of a gaming system having replicating symbols for enhancing awards.

FIG. 4A illustrates one embodiment of a game display 400 that the gaming device 100 may display on a display device of the gaming system. In one embodiment, game display 400 may be displayed on first display 122 of gaming device 100 illustrated in FIG. 1. However, any other suitable display may be used. The game display 400 displays a set of a plurality of virtual video slot machine reels 402a, 402b, 402c, 402d, and 402e as illustrated in FIG. 4A for a primary or base game. As also illustrated in FIG. 4A, the reels 402a-402e are displayed substantially side by side. It should be appreciated that reels 402a-402e can be displayed with any suitable amount of separation or no separation. It should be appreciated that the game shown in game display 400 is merely representative and may have more or fewer game elements (e.g., reels, symbol display areas, symbols, etc.) shown in the game display 400. It should also be appreciated that other games may be used for the primary or base game.

The plurality of reels 402a-402e are each associated with a set of symbols, where each set of symbols includes a plurality of symbols. Each set of symbols can be associated with the same or a different plurality of symbols. The sets of symbols may include numbers, letters, geometric figures, symbols, images, character, blank symbols (e.g., the absence of symbols), animations, transparent symbols (e.g., symbols that permits underlying symbols to be visible), or any other suitable graphical depiction. The symbols in the sets of symbols may include pay symbols and special or designated symbols. In one embodiment, at least one predetermined symbol is a triggering symbol for a bonus game. In one embodiment, at least one triggering symbol must be generated on the reels during a play of a game to trigger the bonus game. In some embodiments, a plurality of triggering symbols must be generated on the reels during a play of a game to trigger the bonus game. In one embodiment, any one of the symbols in the sets of symbols can be designated as the predetermined triggering symbol. The triggering symbol may be associated with one function (e.g., triggering a bonus game), but may alternatively be associated with a plurality of different game functions. The triggering symbol may be a scatter symbol in some embodiments. In some embodiments, generated triggering symbols are not required to trigger a bonus game.

Returning now to FIG. 4A, the game display 400 depicts a plurality of symbol display areas (also referred to herein as symbol display positions) 410a, 410b, 410c, 410d, 410e, 410f, 410g, 410h, 410i, 410j, 410k, 410l, 410m, 410n and 410o. These plurality of symbol display areas can be associated in a manner that provides the appearance of game reels. It should also be appreciated that the symbol display areas may not be associated with game reels in some embodiments. As illustrated in FIG. 4A, symbol display areas 410a, 410b, 410c, 410d, 410e, 410f, 410g, 410h, 410i, 410j, 410k, 410l, 410m, 410n, 410o are associated in a manner that provides the appearance of a set of five slot machine game reels. In one embodiment, the plurality of symbol display areas that provide the appearance of five game reels may be arranged in a manner that visibly shows three symbol positions of each of the five game reels. For example, the symbol display areas 410a-401o are each associated with positions on reels 402a-402e, respectively. As shown in FIG. 4A, symbol display areas 410a, 410f, and 410k are associated with reel 402a; symbol display areas 410b, 410g, and 410l are associated with reel 402b; symbol display areas 410c, 410h, and 410m are associated with reel 402c; and symbol display areas 410d, 410i, and 410n are associated with reel 402d; and symbol display areas 410e, 410j, and 410o are associated with reel 402e. The arrangement illustrated in the embodiment of FIG. 4A thus creates a visible display area of the reels 402a-402e comprising three visible symbol positions for each reel. When viewed together, reels 402a-402e appear like a 3-row by 5-column reel array in display 400. In other embodiments, smaller or larger visible areas of the reels can be displayed. That is, the reels 402a-402e may show fewer or a larger number of visible symbol display areas. In some embodiments, gaming system may include more reels or fewer reels. While symbol display areas are illustrated with defined boxes, it should be appreciated that in some embodiments, the defined boxes are not visible to the player. It should also be appreciated that in some embodiments, the symbol display areas are other shapes or not defined shapes and may not be associated with reels.

Each reel 402a-402e may display a plurality of symbols that the gaming system generates from the sets of symbols in their respective symbol display areas as illustrated in FIG. 4A. In one embodiment, the reels may be shown spinning in one direction to simulate slot machine reels. However, it should be appreciated that the reels may be shown spinning in any suitable direction. The reels may also be shown spinning in different directions in some embodiments.

Game display 400 also includes several information areas and buttons 405a-405i. These information areas and buttons 405a-405i are illustrated in a particular arrangement, but may be arranged in any suitable manner in different embodiments. In some embodiments, game display 400 may include more or fewer display areas and buttons 405a-405i than illustrated. Information area 405a illustrates an example value of one credit for the game displayed in game display 400. Information areas 405b and 405c illustrate an example of the amount of the player's available credits. Information area 405d illustrates the amount of credits a player has won. Because FIG. 4A illustrates the start of a play of a game, the information area 405d shows zero credits have been won. Button 405e illustrates a software button that the player can select to place a bet or wager. It should be appreciated that the functionality of button 405e may also be replicated or replaced with a hardware button on the gaming device 100. Information area 405f illustrates that the player has selected to wager 200 credits, wagering 20 credits for each of 10 pay lines. Button 405g illustrates a software button that the player can select to determine how many pay lines to wager on. It should be appreciated that the functionality of button 405g may also be replicated or replaced with a hardware button on the gaming device 100. Information area 405h illustrates that the player selected to wager on 10 pay lines. Button 405i illustrates a software button that the player can select to obtain information about the game, change certain aspects of the game, obtain help, place an order, etc.

To start a gaming session, a player provides the gaming system with a deposit of value, using one of the suitable mechanisms discussed above. The gaming system receives and validates the player's deposit of value. The gaming system can then issue credits (or gaming credits) to the player based on the received value. The credits enable the player to initiate a play of a game and to also place wagers on a play of the game. The gaming system may provide a visual indication of the player's credit balance to the player as discussed above in information area 405c.

To initiate a play of a game, the player activates or presses one or more appropriate buttons on the gaming system to deduct credits necessary to play the game and to identify the player's wager. Along with receiving the player's wager, the gaming system may receive pay line selections or other game functions the player wishes to activate in exchange for the wager. The player may also actuate a game start button, a spin button, or a lever. The gaming system may deduct the appropriate credits from the player's credit balance after the wager or at any suitable time.

Upon receipt of the player's wager and activation of the game start button, the gaming system may show a display of spinning reels (not shown) for each of the reels 402a-402e. The spinning may appear to occur in a vertical top to bottom direction or in a vertical bottom to top direction (not shown), or in a combination of vertical directions (not shown). In one embodiment, the gaming system randomly generates symbols from the associated sets of symbols for reels 402a-402e, respectively. As noted above, the gaming system may rely on random generation performed by a pseudo RNG, a true RNG, or hardware RNG specifically designed for gaming systems. In one embodiment, the gaming system may also update the player's credit meter (information area 405c) to reflect the player's available credit balance. As shown in FIG. 4A, the player's credit meter (information area 405c) was decremented by 200 credits from 2180 to 1980 to reflect the 200 credit wager the player placed for the play of the game.

The gaming system displays the generated symbols 419a-419o in symbol display areas 410a-410o as illustrated in FIG. 4A. Symbols 419a-419o displayed on reels 402a-402e illustrate the randomly generated symbols from the set of symbols after the reels have stopped spinning. As illustrated in FIG. 4A, the gaming system randomly generated and displayed symbols 419a, 419f, and 419k in symbol display areas 410a, 410f, and 410k for reel 402a. The gaming system also randomly generated and displayed symbols 419b, 419g, and 419l in symbol display areas 410b, 410g, and 410l for reel 402b; symbols 419c, 419h, and 419m in symbol display areas 410c, 410h, and 410m for reel 402c; symbols 419d, 419i, and 419n in symbol display area 410d, 410i, and 410n for reel 402d; symbols 419e, 419j, and 419o in symbol display area 410e, 410j, and 410o for reel 402e.

As illustrated in FIG. 4A, the gaming system generated and displayed Grape symbols (419a, 419b, 419c, 419d, 419e, 419k), Sun symbols (419f, 419g, 419h, 419o), a Seven symbol (419i), Cherry symbols (419j, 419l), a Queen symbol (419m), and an Apple symbol (419n) in the game display 400. It should be appreciated that the displayed symbol combinations are merely for explanatory purposes and the gaming system may randomly generate any suitable combination of symbols based on defined symbol sets associated with the reels 402a-402e.

FIG. 4A further illustrates one embodiment of a gaming system executing an evaluation of the generated symbols on reels 402a-402e for winning symbol combinations. As noted above, the player may have wagered on one or more pay lines (such as 10 pay lines shown in information area 405h). In one embodiment, at least the active (wagered on pay lines) are evaluated for winning symbol combinations. Any suitable number of pay lines may be used to evaluate winning symbol combinations.

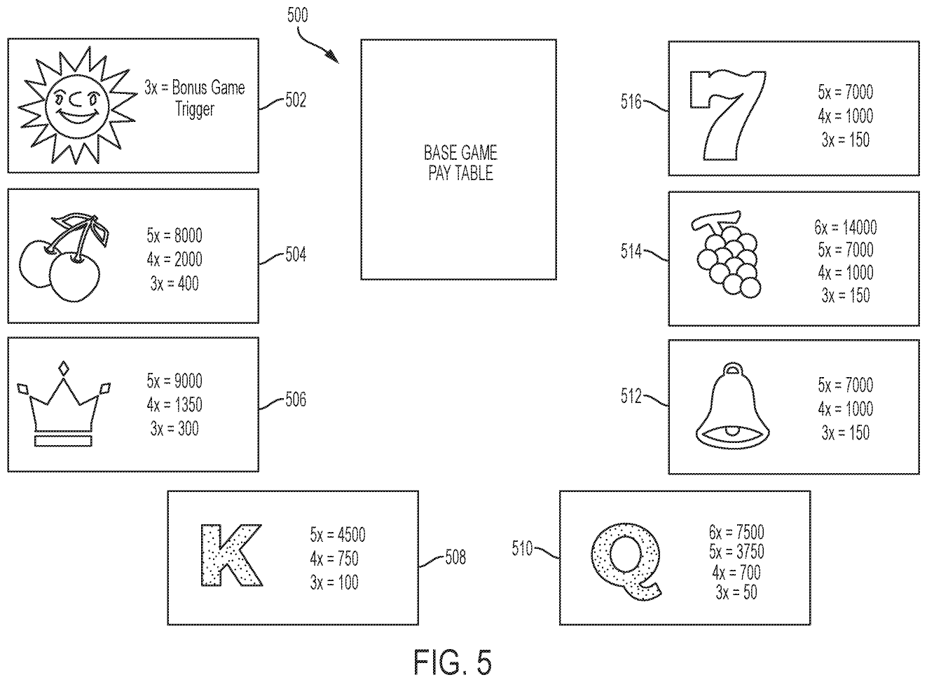

In the embodiment illustrated in FIG. 4A, the gaming system evaluated the generated symbol combinations for winning symbol combinations. In FIG. 4A, the gaming system determined that a winning symbol combination is displayed across one wagered pay line. The pay line spans across a horizontal direction of symbol display areas including symbol display areas 410a, 410b, 410c, 410d, and 410e. In this embodiment, the gaming system displayed five Grape symbols along a horizontal pay line on which the player had placed a wager. The gaming system determined the five Grape symbols form a winning symbol combination based on a pay table associated with the gaming system (such as the base game pay table in FIG. 5). The winning pay line is illustrated as pay line 445 in FIG. 4A across the row of reels 402a-402e. The gaming system may update information area 405d based on the award associated with the winning symbol combination to reflect 7000 credits.

As noted at block 355 of FIG. 3B, in one embodiment, the gaming system may also evaluate the generated symbols on reels 402a-402e for triggering symbols that trigger a bonus game. As illustrated in FIG. 5, a bonus game is triggered when at least three Sun symbols are generated along a pay line. The three Sun symbols also provide a predetermined quantity of free spins for the bonus game in some embodiments. In some embodiments, the gaming system provides spins for the bonus game in exchange for some value from the player. For example, the player may be required to wager at a certain predetermined level or play the game over a certain period of time. In some embodiments, the gaming system may require the player to wager a predetermined amount to obtain the predetermined quantity of spins for the bonus game. It should be appreciated that the predetermined quantity of spins can be three or any other suitable number.

Returning to FIG. 4A, the gaming system determined that three Sun symbols (419f, 419g, and 419h) were generated for the play of the game along wagered pay line 447. In the illustrated embodiment, the Sun symbol was designated as the bonus game triggering symbol. It should be appreciated that any other suitable symbol could be designed as the bonus game triggering symbol. In some embodiments, more than one different symbol can be designated as a bonus triggering symbol. In some embodiments, a combination of different triggering symbols along a pay line may be required to trigger a bonus game. In some embodiments, a predetermined quantity of scatter symbols can be used as a bonus game trigger. In some embodiments, the scatter symbols do not need to appear on a wagered pay line to trigger the bonus game. In some embodiments, the Sun symbols may be scatter symbols that trigger a bonus game. In some embodiments, the gaming system may highlight the Sun symbols in some manner (not shown) so that player understands that the player won a bonus game or other game features. It should be appreciated that the gaming system may highlight the bonus triggering symbol in any suitable manner. It should also be appreciated that the gaming system may not highlight the bonus triggering symbols in some embodiments, as is illustrated in FIG. 4A.

In some embodiments, the gaming system may be required to generate more than one bonus triggering symbol to activate a bonus game (as shown in pay table of FIG. 5). In other embodiments, the features available in the bonus game may depend on the quantity of bonus triggering symbols that the game system generates. In one embodiment, at least one bonus trigging symbol must be generated in the far most reel 402a (in any symbol display area) to trigger the bonus game. That is, if the at least one bonus triggering symbol is generated in reels 402b, 402c, 402d, or 402e, (but not in reel 402a) the gaming system may not activate the bonus game. However, in other embodiments, the bonus triggering symbol may appear on any reel in any symbol display area to trigger the bonus game. In some embodiments, the gaming system may evaluate the bonus triggering symbols from a left to right direction along the reels. In some embodiments, the gaming system may evaluate the bonus triggering symbols from a right to left direction along the reels.

Returning to FIG. 4A, the gaming system determined that three triggering symbols (the Sun symbols 419f, 419g, and 419h) were generated on reels 402a, 402b, and 402c in symbol display areas 410f410g, and 410h. Based on the generated bonus triggering symbol on such reels along wagered pay line 447, the gaming system activates a bonus game. In the illustrated bonus game, the gaming system award one spin for the bonus game.

In one embodiment, the gaming system uses the same symbol sets associated with the same reels for both the primary game and the bonus game, but changes some aspect for the bonus game. In other embodiments, gaming system uses different symbol sets associated with the reels for the bonus game. In some embodiments, as is discussed below, the gaming system selects at least one of the symbols in one of the symbol sets as a replicating symbol. As will be illustrated in FIG. 4B-FIG. 4F, the gaming system selected a wild symbol to be a replicating symbol. In some embodiments, the gaming system may select a pay symbol to be a replicating symbol. In other embodiments, the gaming system may select a pay symbol and a wild symbol to be replicating symbols. In still other embodiments, the gaming system may select a plurality of pay symbols and a plurality of wild symbols are replicating symbols.

FIG. 4B illustrates one embodiment where the player won a bonus game with a free spin. In this illustrated embodiment, the bonus game includes one extra reel 420f over the five reels of the base game. In one embodiment, the gaming system may automatically start the bonus game and execute the free spin (to generate a new plurality of symbols for display on the reels), where a free spin is a play of the bonus game (which occurs within a play of the game). In one embodiment with a plurality of free spins, the gaming system may automatically continue executing the available free spins until no free spins remain. In one alternative embodiment, the gaming system may enable the player to manually start one or more free spins in the bonus game. FIG. 4B further illustrates each of reels 402a-402f displaying a generation of symbols on the reels for the play of the bonus game. FIG. 4B also illustrates predetermined point 435 on anchor 430.

As illustrated in FIG. 4B, the gaming system randomly generated symbols 420a-420r from the sets of symbols associated with reels 402a-402f, respectively. As noted above, the gaming system may rely on random symbol generation performed by a pseudo RNG, a true RNG, or hardware RNG to generate the symbols for the bonus game.

The gaming system displays the generated symbols 420a-420r in symbol display areas 410a-410r as illustrated in FIG. 4B. Symbols 420a-420r displayed on reels 402a-402f illustrate the randomly generated symbols after the reels have stopped spinning. As illustrated in FIG. 4B, the gaming system randomly generated and displayed symbols 420a, 420f, and 420k in symbol display areas 410a, 410f, and 410k for reel 402a. The gaming system also randomly generated and displayed symbols 420b, 420g, and 420l in symbol display areas 410b, 410g, and 410l for reel 402b; symbols 420c, 420h. and 420m in symbol display areas 410c, 410h, and 410m for reel 402c; symbols 420d, 420i, and 420n in symbol display area 410d, 410i, and 410n for reel 402d; symbols 420e, 420j, and 420o in symbol display area 410e, 410j, and 410o for reel 402e; and symbols 420p, 420q, and 420r in symbol display area 410p, 410q, and 410r for reel 402f

As illustrated in FIG. 4B, the gaming system generated and displayed a Wild symbol (410a), Grape symbols (420b, 420c, 420d, 420e, 420k, 420q), Cherry symbols (420f, 420h, 420j, 420o, 420p), a Seven symbol (420i), Queen symbols (420g, 420k, 420l, 420n), an Apple symbol (420m), and an Bell symbol (420r) in the game display 400. It should be appreciated that the displayed symbol combinations are merely for explanatory purposes and the gaming system may randomly generate any suitable combination of symbols based on defined symbol sets associated with the reels 402a-402f As also illustrated in FIG. 4B, the Wild symbol 420a includes a connection point to receive a connector.

FIG. 4C illustrates the gaming system determining that the gaming system generated a replicating symbol (Wild symbol 420a) for the bonus game. In FIG. 4C, the gaming system determines a distance between Wild symbol 420a and predetermined point 435 of anchor 430. Based on the determined distance, the gaming system generates and displays chain 425 in accordance with the determined distance. FIG. 4C further displays chain 425 connected to the predetermined point 435 and connected to the connection point of Wild symbol 420a.

The gaming system also determines a motion path for Wild symbol 420a. In the embodiment illustrated in FIG. 4C, the gaming system determines the motion path based on the fixed predetermined point 435, the length of chain 425, and the position of Wild symbol 420a in symbol display area 410a. As a wild symbol 420a swings with chain 425 about the predetermined point 435, it should be appreciated that wild symbol 420a will move in an arc-shaped path 460. The arc shaped path 460 allows Wild symbol 420a to move through symbol display areas 410g 410m, 410n, 410j, and 410p. In one embodiment, the gaming system also randomly generates at least one stop position for the Wild symbol 420a. In the illustrated embodiment, the at least one stop positions corresponds to one of the symbol display areas in the determined path. As noted above, the gaming system may randomly generate a plurality of stop positions for the Wild symbol 420a. In some embodiments, each of the plurality of stop positions corresponds to a different one of the symbols display areas. In the embodiment illustrated in FIG. 4A-4F, the Wild symbols are replicated (or copied), and the copied version of the Wild symbols are moved along the motion path. As noted above, in some embodiments, the Wild symbols are not replicated until they are placed in a stop position. In some embodiments, the stop positions may not correspond with only one symbol display area. That is, in some embodiments, the stop positions may cause a replicating symbol to overlap two or more symbol display areas. In such embodiments, when the gaming system evaluates the displayed symbols and the replicating symbol, the replicating symbol may be used for each symbol display area that the replicating symbol overlaps or touches.

Turning now to FIG. 4D, the gaming system moves a copy of Wild symbol 420a (which is Wild symbol 421m) along motion path 460 which is in part dictated by the length of chain 425 and the fixed predetermined point 435. In this embodiment, because Wild symbol 420a was generated on the left hand side of reels, the gaming system will move Wild symbol 420a (or its copy, Wild symbol 421m) from left to right along the motion path. On the other hand, if Wild symbol 420a had been generated on the right hand side, such as on reel 402f, the gaming system may move Wild symbol 420a (or its copy) from right to left.

As noted in connection with FIG. 3A-3D, the gaming system may move Wild symbol 421m along the path 460 one or more times. After a predetermined period of time, the gaming system places or drops Wild symbol 421m in the randomly determined stop position. As illustrated in FIG. 4D, the randomly determined stop position corresponds with symbol display area 410m. In some embodiments, where a plurality of stop positions were generated, the gaming system may place Wild symbol 421m in a first stop position and then generate another copy of Wild symbol 420a for each of the plurality of stop positions. In an alternative embodiment, the gaming system may generate copies of Wild symbol 421m for each of the plurality of stop positions.

As is illustrated in FIG. 4D, the gaming system placed Wild symbol 421m over Apple symbol 420m. In some embodiments, the replicating symbol will be layered over an existing symbol in a stop position without replacing the existing symbol. In other embodiments, the gaming system removes any symbol in a symbol display area that is also occupied by a replicating symbol. That is, in one embodiment, when the gaming system places the Wild symbol 421m in symbol display area 410m, the gaming system also removes the Apple symbol 420m.

In the embodiment illustrated in FIG. 4E, the gaming system evaluated the generated symbol combinations for winning symbol combinations. In FIG. 4E, the gaming system determined that three separate winning symbol combinations were displayed across three pay lines. The three pay lines span across a horizontal direction of symbol display areas including symbol display areas 410a, 410b, 410c, 410d, and 410e; symbol display areas 410k, 410l, 410m, and 410n; and symbol display areas 410a, 410g, and 410m. In this embodiment, the gaming system displayed four Grape symbols along a horizontal pay line on which the player had placed a wager. The gaming system also evaluated the Wild symbol 420a as another Grape symbol. The gaming system determined that five Grape symbols form a winning symbol combination based on a pay table associated with the gaming system (such as the pay table in FIG. 5). The first winning pay line is illustrated as pay line 448 in FIG. 4E across the row of reels 402a-402f. In this embodiment, the gaming system also displayed three Queen symbols along another horizontal pay line on which the player had placed a wager. The gaming system further evaluated the Wild symbol 421m (replicated replicating symbol) as another Queen symbol. The gaming system determined that four Queen symbols form a winning symbol combination based on a pay table associated with the gaming system (such as the pay table in FIG. 5). The second winning pay line is illustrated as pay line 449 in FIG. 4E across the row of reels 402a-402d. In this embodiment, the gaming system also displayed one Queen symbol along a horizontal pay line on which the player had placed a wager. The gaming system also evaluated the Wild symbol 420a and Wild symbol 421m as Queen symbols. The gaming system determined that three Queen symbols form a winning symbol combination based on a pay table associated with the gaming system (such as the pay table in FIG. 5). The third winning pay line is illustrated as pay line 450 in FIG. 4E across the row of reels 402a-402c. The gaming system may update information area 405d based on the award associated with the winning symbol combination to reflect 7450 credits. In this embodiment, the gaming system ignored the Apple symbol 420m for purposes of evaluating the displayed symbols for winning symbol combinations.

In alternative embodiments, the gaming system may perform an initial evaluation of the displayed symbols for winning symbol combinations using the Apple symbol 420m (or some symbol covered or replaced by a replicating symbol). In this alternative embodiment, the gaming system may also perform another evaluation of the displayed symbols for winning symbol combinations while ignoring the Apple symbol 420m and using a replicated or copied replicating symbol in place of the Apple symbol 420m. In some such embodiments, the gaming system may provide the player with any award associated with both evaluations (awards without the replicating symbol and awards with the replicating symbol), thus the replicating symbol can be used to increase the amount of symbols available for evaluating winning symbol combinations in some embodiments.

In some embodiments, the gaming system evaluates all symbols generated and displayed for this bonus game illustrated in FIG. 4E. However, in some embodiments, the gaming system skips evaluating pay lines that do not include replicating symbols. By skipping evaluation of all of the generated and displayed symbols, the efficiency of the gaming system can be improved because less memory and less processing power is used during the gaming system's evaluation after each free spin. This efficiency also translates into faster game play because less time is used to complete the game's evaluation. When such efficiency improvements are made and applied to the hundreds and thousands of games evaluations that are made on a casino floor during a given period of time for the disclosed gaming system, the new gaming system will provide casino game operators sizable gains in machine efficiency.

In the illustrated embodiment, no spins of the bonus game remains. Therefore, the gaming system does not generate additional symbols for symbol display areas in the bonus game and the play of the game and the bonus game ends. The player may continue to play additional games or cash out as discussed in connection with FIGS. 3A-3D. While the embodiment illustrated in FIG. 4A-4F did not include multiple spins of the bonus game, in some embodiments, the bonus game includes multiple spins and the bonus game may continue.

Turning now to FIG. 4F, the gaming system in one embodiment provides the player with information regarding all of the awards for the play of the game. In this embodiment, the gaming system alerts the player that the player won 7450 credits in the bonus game. In some embodiments, the gaming system may break down how the player won the credits. For example, the gaming system may describe that the five Grape symbols along a wagered pay line pays 7000 credits (e.g., based on the pay table illustrated in FIG. 5). The gaming system may also describe that the four Queen symbols along a wagered pay line pays 400 credits (e.g., based on the pay table illustrated in FIG. 5). The gaming system may also describe that the three Queen symbols along a wagered pay line pays 50 credits (e.g., based on the pay table illustrated in FIG. 5). It should also be appreciated that the awards illustrated in FIG. 4F and FIG. 5 are merely illustrative and could be adjusted to include any suitable awards and different credit amounts.

As illustrated in FIG. 4F, the gaming system awards the appropriate number of credits to the player and updates the player's win meter (shown in information area 405d) to reflect the player's winnings during the play of the bonus game. In one embodiment, the gaming system may also update the player's credit meter (information area 405c) to reflect the player's available credit balance based on awards from the base game and the bonus game.

If the player does not have additional spins of the bonus game, the player may continue the gaming session by playing another play of the game. That is, the player may place another wager and start a new play of the game, as noted above. However, continued game play is dependent of the number of credits remaining in the player's credit balance. The player may also choose to cash out. In such an instance, the gaming system provides the player a value based on the player's credit balance using any of the value items discussed above (bills, coins, vouchers, etc.).

FIG. 5 illustrates a screen shot of one embodiment of a pay table 500 for a base game of the gaming system. Tables 502, 504, 506, 508, 510, 512, 514, and 516 are merely example payout awards for example symbol combinations. As noted above, it should be appreciated that the pay table is merely illustrative, and the symbols, awards, and the credit values may all be modified in any suitable manner.

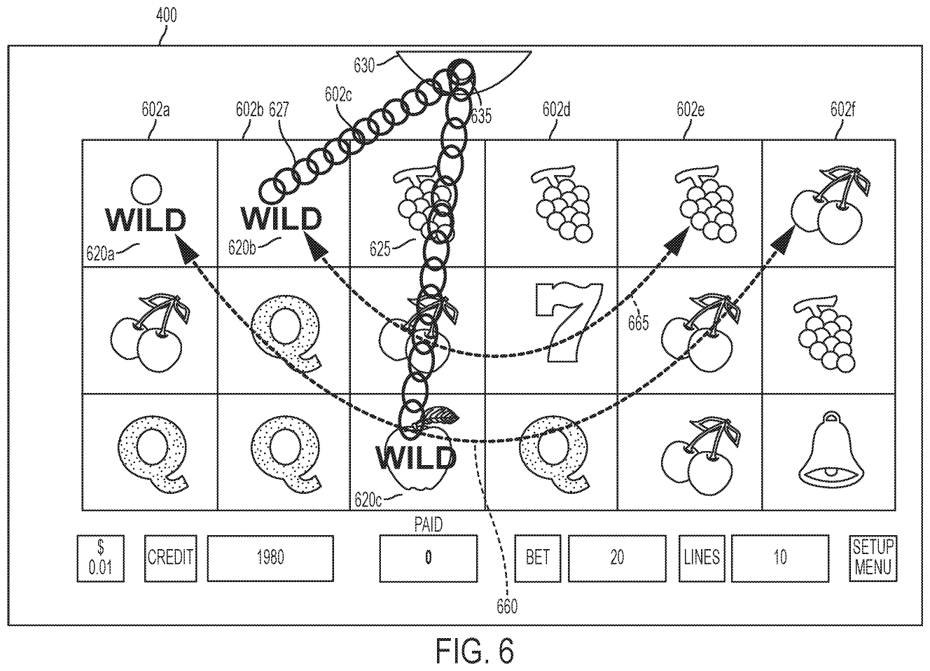

FIG. 6 illustrates a screen shot of one embodiment of a gaming system having replicating symbols for enhancing awards. The game depicted in FIG. 6 is similar to the game described in FIG. 4A-4F and similar elements will not all be described again for the sake of brevity. Like in FIG. 4A-4F, the game display 600 displays a set of a plurality of virtual video slot machine reels 602a, 602b, 602c, 602d, 602e, and 602f as illustrated in FIG. 6 for a primary or base game. It should be appreciated that the game shown in game display 600 is merely representative and may have more or fewer game elements (e.g., reels, symbol display areas, symbols, etc.) than shown in the game display 600. It should also be appreciated that other games may be used for the primary or base game.

Unlike FIG. 4A-4F, the gaming system generated two replicating symbols, Wild symbol 420a and Wild symbol 420b, during a play of a bonus game. As a result, gaming system performed the features described in FIG. 3D for each of Wild symbol 420a and Wild symbol 420b (i.e., replicating symbols). In some embodiments, the features described in FIG. 3D are applied to each replicating symbol in series (the gaming system does not act upon one replicating symbol until a currently executing replicating process of FIG. 3D is complete for another replicating symbol). However, as noted in FIG. 3A-3D, the process 300 can be executed in different suitable orders. In the embodiment illustrated in FIG. 6, the gaming system generated a chain 625 connecting a copy of Wild symbol 620a (e.g., Wild symbol 620c) to the predetermined point 635 on anchor 630. In the embodiment illustrated in FIG. 6, the gaming system also generated a chain 627 connecting a copy of Wild symbol 620b (not visible) to the predetermined point 635 on anchor 630. The gaming system also determined a motion path for each of the Wild symbol 620a and Wild symbol 620b. The motion paths are path 660 and path 665 and are determined in a manner similar to the manners discussed above. The gaming system can determine stop positions for the replicating symbols in a manner similar to the manners discussed above. In FIG. 6, the gaming system moves Wild symbol 620c (a copy of Wild symbol 620a) along its determined path 660 and will eventually place Wild symbol 620c in at least one determined stop position. FIG. 6 illustrates that Wild symbol 620b (or its copy) is not moved along its determined path 665 while the gaming system moves Wild symbol 620c along its determined path 660. In alternative embodiments, the process described in FIG. 3D for replicating symbols may occur in parallel for each displayed replicating symbol. In some embodiments, the gaming system may move Wild symbol 620c and a copy of Wild symbol 620b on their respective paths at approximately the same time. The gaming system may place Wild symbol 620c and a copy of Wild symbol 620b in their respective stop positions at substantially the same time or at different times. Evaluations for winning symbol combinations and award determinations can be performed after each Wild symbol 620a and Wild symbol 620b have been replicated in some embodiments. In other embodiments, the evaluations for winning symbol combinations and award determinations can be performed after all replicating symbols have been replicated.

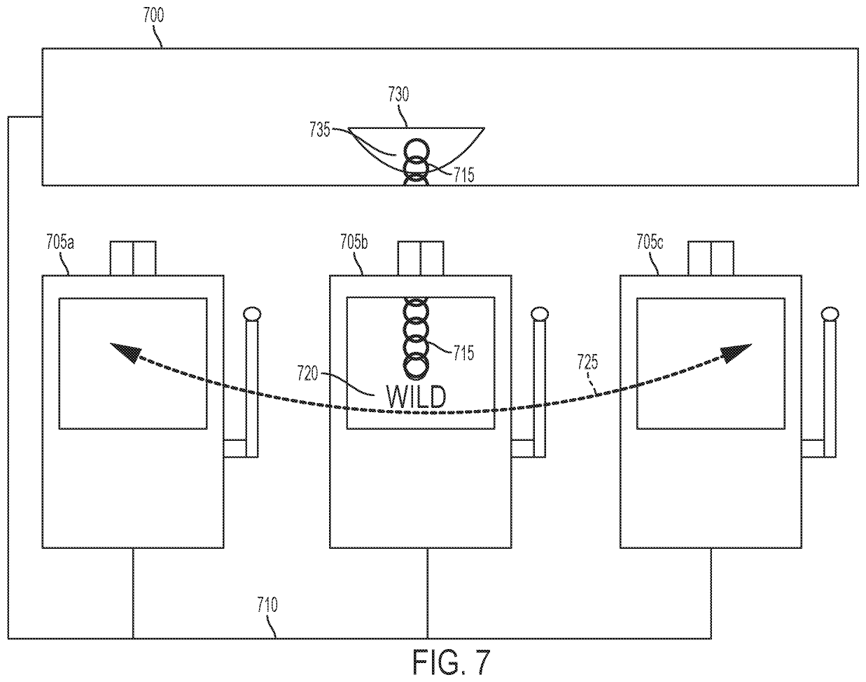

FIG. 7 illustrates a plurality of gaming systems that are in communication with each other over network 710. The plurality of gaming system can communicate to generate a unified game having replicating symbols. Gaming systems 705a, 705b, and 705c are a representation of a plurality of network gaming systems. There may be more or fewer gaming systems that are in communications with each other. The networked gaming systems may also be in communication with a separate display screen 700. The display screen 700 can communicate with the networked gaming systems 705a-705c to create a unified game using the replicating symbols. In some embodiments, the separate display screen 700 may display the predetermined point 735 on anchor 730. In some embodiments, if one of the plurality of gaming systems generates a replicating symbol, one or more of the gaming systems may determine a path for the replicating symbol that moves across two or more of the plurality of linked gaming systems. In the embodiment illustrated in FIG. 7, gaming system 705b generated a replicating symbol (Wild symbol 720). The gaming system 705b determined a distance between the predetermined point 735 and the Wild symbol 720. The gaming system 705b generated a chain connector 715, whose length is based on the determined distance. In some embodiments, the gaming system 705b also determines a path based on the predetermined point 735, the chain 715, and the position of the Wild symbol 720 as discussed above. In the illustrated embodiment, the path 725 spans across a plurality of gaming systems 705a, 705b, and 705c. The path can span across more or fewer gaming systems. Gaming system 705b may determine one or more stop positions for the Wild symbol 720 along path 725. In one embodiment, at least one stop position along path 725 is on gaming system 705b and at least one other stop position is on another one of the gaming systems. In some embodiments, the stop position is always on a gaming system other than the gaming system that generated the replicating symbol. In some embodiments, a stop position is determined for each gaming system that is in the path 725. While gaming system 705b is described as executing the process 300 of FIG. 3D for the game illustrated in FIG. 7, any suitable other machine or server may perform the process 300 of FIG. 3D. The process 300 may be handled by one of the other gaming systems 705a or 705c; the process 300 may be handled by a server in communication with the gaming systems 705a, 705b, 705c, and the display screen 700 over network 710.

In some embodiments, the unified game having replicating symbols across a plurality of gaming system is not activated until a predetermined amount of wagers are placed at the plurality of gaming systems. In some embodiments, the unified game having replicating symbols across a plurality of gaming system is activated regardless or independent of placed wagers. In some embodiments, the unified game having replicating symbols across a plurality of gaming systems is not activated until one or more of the network gaming systems have been in use for a predetermined amount of time. It should be appreciated that any suitable criteria may be used to restrict when the network gaming systems may generate the unified game having replicating symbols.

Based on the forgoing description, it should be appreciated that a gaming system and method with improvements to game outcomes based on replicating symbols creates new and very exciting ways for a player to obtain improved winnings with a potential to earn frequent and greater awards or to turn a losing gaming into a winning game. Such a potential to earn greater awards creates a greatly improved sense of anticipation for players.

A number of embodiments of the invention have been described. Various modifications may be made without departing from the spirit and scope of the invention. For example, various forms of the flows shown above may be used, with steps re-ordered, added, or removed. Accordingly, other embodiments are within the scope of the following claims.

1. A gaming system comprising:
a processor;
a random number generator
a display device;
an input device;
a dispenser;
a memory device that stores a plurality of instructions which, when executed by the processor, cause the processor to:
randomly generate, using the random number generator, a plurality of symbols;
display, using the display device, the plurality of symbols;
determine that a replicating symbol was generated in the plurality of symbols;
in response to determining that the replicating symbol was generated, determine a distance between a predetermined point of the display device and the replicating symbol;
generate and display, using the display device, a connector between the predetermined point of the display device and the replicating symbol, where a length of the connector is based on the determined distance;
determine a path on the display device to move the replicating symbol across the displayed plurality of symbols, where the path on the display device is based on a position of the replicating symbol, a location of the predetermined point of the display device, and the length of the connector;
randomly determine, using the random number generator, a stop position for the replicating symbol along the determined path on the display device;
display, using the display device, a second replicating symbol at the stop position;
determine awards based on the plurality of symbols and the second replicating symbol, where the determination ignores one of the plurality symbols that is in the same position as the second replicating symbol;
display, using the display device, the determined awards; and
issue value from the dispenser based on the determined awards.

2. The gaming system of claim 1, wherein the second replicating symbol is a copy of the replicating symbol.

3. The gaming system of claim 1, wherein the processor further moves the replicating symbol and the connector along the determined path.

4. The gaming system of claim 1, wherein the path is an arc that is determined based on the length of the connector.

5. The gaming system of claim 1, wherein the processor further determines a plurality of stop positions along the path.

6. The gaming system of claim 5, wherein for each of the plurality of stop positions along the path the processor further generates and displays copies of the replicating symbol.

7. The gaming system of claim 1, wherein the replicating symbol returns to a start position of the path after displaying the second replicating symbol.

8. (canceled)

9. The gaming system of claim 1, wherein:
the processor further determines that a plurality of replicating symbols were generated in the plurality of symbols; and
for each of the generated replicating symbols:
determine a new distance between the predetermined point and one of the plurality of replicating symbols;
generate and display a new connector between the predetermined point and the one of the plurality of replicating symbols, where a length of the connector is based on the determined distance;
determine a new path to move the one of the plurality of replicating symbols across the displayed plurality of symbols, where the path is based on a position of the one of the plurality of replicating symbols, a location of the predetermined point, and the length of the connector;
randomly determine a new stop position for the one of the plurality of replicating symbols along the determined path;
display at least one new replicating symbol at the stop position; and
determine any awards based on the plurality of symbols and any new replicating symbols, where the determination ignores one of the plurality symbols that is in the same position as any of the new replicating symbols.

10. The gaming system of claim 1, wherein:
if the replicating symbol is displayed in a first area of the display, the replicating symbol will move in a first direction along the path; and
if the replicating symbols displayed in a second area of the display, the replicating symbol will move in a second direction along the path.

11. The gaming system of claim 1, wherein the replicating symbol is displayed on one of a plurality of reels and the path extends across all of the plurality of reels.

12. The gaming system of claim 1, wherein the replicating symbol is a pay symbol.

13. The gaming system of claim 1, wherein:
the second replicating symbol is a wild symbol; and
if the one of the plurality of symbols that is in the same position as the second replicating symbol and the one of the plurality of symbols is another wild symbol, the processor further evaluates the second replicating symbol as a multiplier for the any determined awards.

14. The gaming system of claim 1, wherein the path is further determined across a plurality of gaming systems.

15. The gaming system of claim 1, wherein the determination of whether the replicating symbol was generated in the plurality symbols is performed in a base game.

16. The gaming system of claim 1, wherein the determination of whether the replicating symbol was generated in the plurality symbols is performed in a bonus game.

17. The gaming system of claim 1, wherein the path is linear.

18. The gaming system of claim 1, wherein:
the processor further generates a copy of the replicating symbol and moves the copy of the replicating symbol along the path; and
the second replicating symbol is a second copy of the copy of the replicating symbol.

19. A method of operating a gaming system, the method comprising:
randomly generating, by the processor using a random number generator, a plurality of symbols;
displaying, by the processor using a display device of the housing, the plurality of symbols;
determining, by the processor, that a replicating symbol was generated in the plurality of symbols;
in response to determining that the replicating symbol has been generated, determining, by the processor, a distance between a predetermined point of the display device and the replicating symbol;
generating and displaying, by the processor, a connector between the predetermined point of the display device and the replicating symbol, where a length of the connector is based on the determined distance;
determining, by the processor, a path on the display device to move the replicating symbol across the displayed plurality of symbols, where the path on the display device is based on a position of the replicating symbol, a location of the predetermined point of the display device, and the length of the connector;
randomly determining, by the processor using the random number generator, a stop position for the replicating symbol along the determined path on the display device;
displaying, by the processor using the display device, a second replicating symbol at the stop position;
determining, by the processor, awards based on the plurality of symbols and the second replicating symbol, where the determination ignores one of the plurality symbols that is in the same position as the second replicating symbol;
displaying, by the processor using the display device, the determined awards; and
issuing, by the processor using a dispenser, value based on determined awards.

20. A non-transitory computer-readable storage medium having machine instructions stored therein, the instructions being executable by a processor to cause the processor to:
randomly generate, using a random number generator, a first plurality of symbols;
display, using a display device of the housing, the plurality of symbols;
determine that a replicating symbol was generated in the plurality of symbols;
in response to determining that the replicating symbol is determined to have been generated, determine a distance between a predetermined point of the display device and the replicating symbol;
generate and display, using the display device, a connector between the predetermined point of the display device and the replicating symbol, where a length of the connector is based on the determined distance;
determine a path in the display device to move the replicating symbol across the displayed plurality of symbols, where the path on the display device is based on a position of the replicating symbol, a location of the predetermined point of the display device, and the length of the connector;
randomly determine a stop position for the replicating symbol along the determined path on the display device;
display, using the display device, a second replicating symbol at the stop position;
determine awards based on the plurality of symbols and the second replicating symbol, where the determination ignores one of the plurality symbols that is in the same position as the second replicating symbol;
display, on the display device, the determined awards; and issue value from a value dispenser based on the determined awards.

21. The gaming system of claim 1, wherein:
determining the awards comprises evaluating winning combinations of the plurality of symbols and the second replicating symbol included in a plurality of paylines; and
the evaluating does not evaluate individual paylines of the plurality of paylines that lack replicating symbols so as to improve the efficiency of the gaming system by using less memory, using less processing power, or reducing time to complete the evaluating.
